(19) United States
(12) Patent Application Publication
(10) Pub. No.: US 2023/0396301 A1
(43) Pub. Date: Dec. 7, 2023

(54) COMMON BEAM INDICATION TECHNIQUES FOR MULTI-BEAM OPERATION

(71) Applicant: QUALCOMM INCORPORATED, San Diego, CA (US)

(72) Inventors: Fang YUAN, Beijing (CN); Yan ZHOU, San Diego, CA (US); Wooseok NAM, San Diego, CA (US); Xiaoxia ZHANG, San Diego, CA (US); Tao LUO, San Diego, CA (US); Juan MONTOJO, San Diego, CA (US)

(21) Appl. No.: 18/252,139

(22) PCT Filed: Dec. 10, 2020
(86) PCT No.: PCT/CN2020/135300

§ 371 Date: May 8, 2023

(51) Int. Cl. H04B 7/06; H04L 5/00; H04B 7/0408; H04B 7/0417

(52) U.S. Cl. CPC H04B 7/0628; H04L 5/0053; H04B 7/0408; H04B 7/0417

(57) ABSTRACT

This disclosure provides systems, methods and apparatus for multi-beam operation at a user equipment (UE). In some aspects, a user equipment (UE) may transmit a beam report indicating a number of simultaneous transmit beams supported by the UE. The UE may receive a common beam indication for multiple TCI states. The UE may select at least one TCI state as an uplink component for a common beam and may communicate with a base station (BS) using the common beam. The UE may receive control signaling enabling a group-based beam reporting mode at the UE and an indication to apply a group-based beam reporting configuration for uplink beam reporting. The UE may selectively enable or disable the group-based beam reporting configuration. The UE may report multiple reference signal resource indices for multiple reference signals. The UE may transmit the reference signals using multiple spatial domain transmit filters.

### CROSS REFERENCE

The present application is a 371 national stage filing of International PCT Application No. PCT/CN2020/135300 by YUAN et al. entitled “COMMON BEAM INDICATION TECHNIQUES FOR MULTI-BEAM OPERATION,” filed Dec. 10, 2020, which is assigned to the assignee hereof, and which is expressly incorporated by reference in its entirety herein.

### TECHNICAL FIELD

This disclosure relates to wireless communications, including common beam indication techniques for multi-beam operation.

### DESCRIPTION OF THE RELATED TECHNOLOGY

Wireless communications systems are widely deployed to provide various types of communication content such as voice, video, packet data, messaging, broadcast, and so on. These systems may be capable of supporting communication with multiple users by sharing the available system resources (for example, time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations (BSs) or one or more network access nodes, each simultaneously supporting communication for multiple communication devices, which may be otherwise known as user equipment (UE).

### SUMMARY

The systems, methods and devices of this disclosure each have several innovative aspects, no single one of which is solely responsible for the desirable attributes disclosed herein.

One innovative aspect of the subject matter described in this disclosure can be implemented in a method for wireless communications at a wireless communication device is described. The method may include transmitting a beam report indicating a number of simultaneous transmit beams supported by the user equipment (UE), receiving control signaling including a common beam indication associated with a set of multiple transmission configuration indicator (TCI) states, selecting at least one TCI state of the set of multiple TCI states as an uplink component of a common beam, where the at least one TCI state is selected based on a selection criterion associated with the common beam indication and the number of simultaneous transmit beams supported by the UE, and communicating with a base station (BS) using the common beam.

Another innovative aspect of the subject matter described in this disclosure can be implemented in an apparatus for wireless communications at a wireless communication device is described. The apparatus may include a processor, memory in electronic communication with the processor, and instructions stored in the memory. The instructions may be executable by the processor to cause the apparatus to transmit a beam report indicating a number of simultaneous transmit beams supported by the UE, receive control signaling including a common beam indication associated with a set of multiple transmission configuration indicator (TCI) states, select at least one TCI state of the set of multiple TCI states as an uplink component of a common beam, where the at least one TCI state is selected based on a selection criterion associated with the common beam indication and the number of simultaneous transmit beams supported by the UE, and communicate with a base station (BS) using the common beam.

Another innovative aspect of the subject matter described in this disclosure can be implemented in an apparatus for wireless communications at a wireless communication device is described. The apparatus may include means for transmitting a beam report indicating a number of simultaneous transmit beams supported by the UE, means for receiving control signaling including a common beam indication associated with a set of multiple transmission configuration indicator (TCI) states, means for selecting at least one TCI state of the set of multiple TCI states as an uplink component of a common beam, where the at least one TCI state is selected based on a selection criterion associated with the common beam indication and the number of simultaneous transmit beams supported by the UE, and means for communicating with a base station (BS) using the common beam.

Another innovative aspect of the subject matter described in this disclosure can be implemented in a non-transitory computer-readable medium storing code for wireless communications at a wireless communication device is described. The code may include instructions executable by a processor to transmit a beam report indicating a number of simultaneous transmit beams supported by the UE, receive control signaling including a common beam indication associated with a set of multiple transmission configuration indicator (TCI) states, select at least one TCI state of the set of multiple TCI states as an uplink component of a common beam, where the at least one TCI state is selected based on a selection criterion associated with the common beam indication and the number of simultaneous transmit beams supported by the UE, and communicate with a base station (BS) using the common beam.

Another innovative aspect of the subject matter described in this disclosure can be implemented in a method for wireless communications at a wireless communication device is described. The method may include receiving first control signaling enabling a group-based beam reporting mode at the UE, receiving second control signaling including an indication associated with applying a group-based beam reporting configuration for uplink beam reporting, and selectively enabling or disabling the group-based beam reporting configuration to an uplink transmission, a downlink reception, or both based on the indication.

Another innovative aspect of the subject matter described in this disclosure can be implemented in an apparatus for wireless communications at a wireless communication device is described. The apparatus may include a processor, memory in electronic communication with the processor, and instructions stored in the memory. The instructions may be executable by the processor to cause the apparatus to receive first control signaling enabling a group-based beam reporting mode at the UE, receive second control signaling including an indication associated with applying a group-based beam reporting configuration for uplink beam reporting, and selectively enable or disable the group-based beam reporting configuration to an uplink transmission, a downlink reception, or both based on the indication.

Another innovative aspect of the subject matter described in this disclosure can be implemented in an apparatus for wireless communications at a wireless communication device is described. The apparatus may include means for receiving first control signaling enabling a group-based beam reporting mode at the UE, means for receiving second control signaling including an indication associated with applying a group-based beam reporting configuration for uplink beam reporting, and means for selectively enabling or disabling the group-based beam reporting configuration to an uplink transmission, a downlink reception, or both based on the indication.

Another innovative aspect of the subject matter described in this disclosure can be implemented in a non-transitory computer-readable medium storing code for wireless communications at a wireless communication device is described. The code may include instructions executable by a processor to receive first control signaling enabling a group-based beam reporting mode at the UE, receive second control signaling including an indication associated with applying a group-based beam reporting configuration for uplink beam reporting, and selectively enable or disable the group-based beam reporting configuration to an uplink transmission, a downlink reception, or both based on the indication.

Another innovative aspect of the subject matter described in this disclosure can be implemented in a method for wireless communications at a wireless communication device is described. The method may include receiving first control signaling including a first indication associated with enabling a group-based beam reporting mode for an uplink transmission at the UE, transmitting, in response to the first indication, a report including a set of multiple indices corresponding to a set of multiple reference signal resources, and transmitting a set of multiple reference signals over the set of multiple reference signal resources using a set of multiple spatial domain transmit filters based on the report.

Another innovative aspect of the subject matter described in this disclosure can be implemented in an apparatus for wireless communications at a wireless communication device is described. The apparatus may include a processor, memory in electronic communication with the processor, and instructions stored in the memory. The instructions may be executable by the processor to cause the apparatus to receive first control signaling including a first indication associated with enabling a group-based beam reporting mode for an uplink transmission at the UE, transmit, in response to the first indication, a report including a set of multiple indices corresponding to a set of multiple reference signal resources, and transmit a set of multiple reference signals over the set of multiple reference signal resources using a set of multiple spatial domain transmit filters based on the report.

Another innovative aspect of the subject matter described in this disclosure can be implemented in an apparatus for wireless communications at a wireless communication device is described. The apparatus may include means for receiving first control signaling including a first indication associated with enabling a group-based beam reporting mode for an uplink transmission at the UE, means for transmitting, in response to the first indication, a report including a set of multiple indices corresponding to a set of multiple reference signal resources, and means for transmitting a set of multiple reference signals over the set of multiple reference signal resources using a set of multiple spatial domain transmit filters based on the report.

Another innovative aspect of the subject matter described in this disclosure can be implemented in a non-transitory computer-readable medium storing code for wireless communications at a wireless communication device is described. The code may include instructions executable by a processor to receive first control signaling including a first indication associated with enabling a group-based beam reporting mode for an uplink transmission at the UE, transmit, in response to the first indication, a report including a set of multiple indices corresponding to a set of multiple reference signal resources, and transmit a set of multiple reference signals over the set of multiple reference signal resources using a set of multiple spatial domain transmit filters based on the report.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 illustrates an example of a wireless communications system that supports common beam indication techniques for multi-beam operation.

FIGS. 2 and 3 illustrate examples of communication techniques to indicate a common beam for multi-beam operation.

FIGS. 4 and 5 illustrate examples of beam diagrams that support common beam indication techniques for multi-beam operation.

FIGS. 6-8 illustrate examples of transmission diagrams that support common beam indication techniques for multi-beam operation.

FIGS. 9-11 illustrates an example of process flows that support common beam indication techniques for multi-beam operation.

FIG. 12 shows a block diagram of an example device that support common beam indication techniques for multi-beam operation.

FIGS. 13-15 show flowcharts illustrating methods that support common beam indication techniques for multi-beam operation.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, system or network that is capable of transmitting and receiving radio frequency (RF) signals according to any of the IEEE 16.11 standards, or any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, or further implementations thereof, technology.

In some wireless communications systems, a user equipment (UE) may be configured with beam indications, such as transmission configuration indicators (TCIs), associated with uplink and downlink resources of one or more beams. For example, the UE may receive signaling configuring the UE to operate in a TCI state, which may identify a beam. The UE may decode a downlink transmission from a base station (BS) based on a TCI state for a beam used for the downlink transmission. Similarly, the UE may transmit an uplink transmission to a BS based on a TCI state for a beam used for the uplink transmission. In some implementations, such as when the UE communicates across multiple component carriers, the UE may communicate uplink and downlink transmissions using a common beam. Thus, operating based on separate TCI states for uplink and for downlink communications may result in additional processing time as well as signaling and network overhead. Therefore, the UE may use a joint uplink and downlink TCI state to communicate uplink and downlink transmissions across multiple component carriers using a common beam. Aspects of this disclosure include solutions for the UE to perform multi-beam operation (such as a simultaneous multi-beam reception operation, a simultaneous multi-beam transmission operation, or both) based on an indication of a common beam for uplink and downlink communications.

In some implementations, a UE may receive a common beam indication from a base station, which may include one or more TCI states. Each TCI state may provide beam information for one or more physical channels. The UE may select a TCI state as an uplink component of a common beam based on the common beam indication. Additionally, or alternatively, the UE may select a TCI state based on a capability of the UE to support simultaneous transmit beams.

For example, a UE may receive control signaling enabling a common beam indication for multi-beam reception in downlink and single beam transmission in uplink. The UE may receive an indication of a pair of TCI states corresponding to uplink transmission and downlink reception for a common beam. The UE may select a TCI state from the pair of TCI states, or both TCI states of the pair of TCI states, as an uplink component of the common beam (such as based on a number of simultaneous transmit beams supported by the UE). In some implementations, the UE may be configured with a multiplexing mode (such as a spatial division multiplexing (SDM) mode, a time division multiplexing (TDM) mode, a frequency division multiplexing (FDM) mode, a single-frequency network (SFN) mode, or a combination thereof) for downlink multi-beam reception that is different from a multiplexing mode for uplink multi-beam transmission. In some examples of multi-beam reception and multi-beam transmission, the UE may apply a first TCI state of the pair of TCI states to a first downlink reception and uplink transmission occasion and a second TCI state of the pair of TCI states to a second downlink reception and uplink transmission occasion. Additionally, the UE may apply a reference signal with the first TCI state as the pathloss reference signal for a first uplink transmission occasion and a reference signal with the second TCI state as the pathloss reference signal for a second uplink transmission occasion. The UE may apply a timing advance for the first TCI state as the timing advance for a first uplink transmission occasion and a timing advance the second TCI state as the timing advance for a second uplink transmission occasion.

Additionally, or alternatively, a UE may receive control signaling (such as from a BS or a transmission reception point (TRP)) that enables a group-based beam reporting mode at the UE. For example, the UE may be configured with a higher layer parameter for group-based beam reporting that is set to enabled. The UE may receive additional control signaling (such as channel state information (CSI) report configuration, a CSI report, a UE capability report, or a combination thereof) indicating whether the group-based downlink beam reporting may be applied for an uplink simultaneous transmission. In some implementations, such as if the UE is configured with the higher layer parameter enabling group-based beam reporting, the UE may not expect to receive the indication to perform the uplink simultaneous transmission. The UE may enable or disable the group-based beam reporting configuration for an uplink transmission, a downlink reception, or both.

Additionally, or alternatively, a UE may receive control signaling (such as from a BS or a TRP) that enables a group-based beam reporting mode for uplink transmission at the UE. The UE may transmit a report including multiple indices, each index corresponding to a reference signal resource. The UE may transmit reference signals over the indicated reference signal resources simultaneously using multiple spatial domain filters.

Particular implementations of the subject matter described in this disclosure can be implemented to realize one or more of the following potential advantages. A UE may implement a common beam for both uplink transmission and downlink reception by supporting multi-beam operation based on control signaling. In some implementations, a UE may apply quasi-collocation (QCL) criteria (such as assumptions) or a spatial domain filter associated with a single TCI state or multiple TCI states based on a common beam indication and a number of simultaneous transmit beams supported by the UE. In some other implementations, the UE may selectively enable group-based beam reporting based on control signaling. Thus, the UE may communicate with a BS or a TRP using a common beam for uplink transmissions and downlink receptions even for multi-beam operation, which may reduce processing overhead and latency involved with the UE being configured with separate beams for communication in both the uplink and downlink direction. Additionally, the UE may perform one or more simultaneous uplink transmissions if group-based beam reporting is enabled, which may reduce signaling overhead and latency related to transmitting the uplink transmissions at different times.

In some implementations, the UE may transmit one or more reference signals using multiple spatial domain transmit filters based on receiving control signaling enabling a group-based beam reporting mode for an uplink transmission at the UE. The UE may simultaneously transmit the one or more reference signals, which may reduce signaling overhead related to transmitting the reference signals at different times (such as if group-based beam reporting is disabled).

In some implementations, a common beam indication for downlink and uplink may be applied to different multi-beam configurations in downlink and uplink. For example, a single common beam indication instance of multiple TCI states may be applied for multi-beam downlink receptions and uplink transmission for one or more physical channels, regardless of whether the UE is capable of uplink transmission of single or multiple beams. In this way, the beam indication may be simplified and unified for wireless communications systems of different multi-beam operations in downlink and uplink.

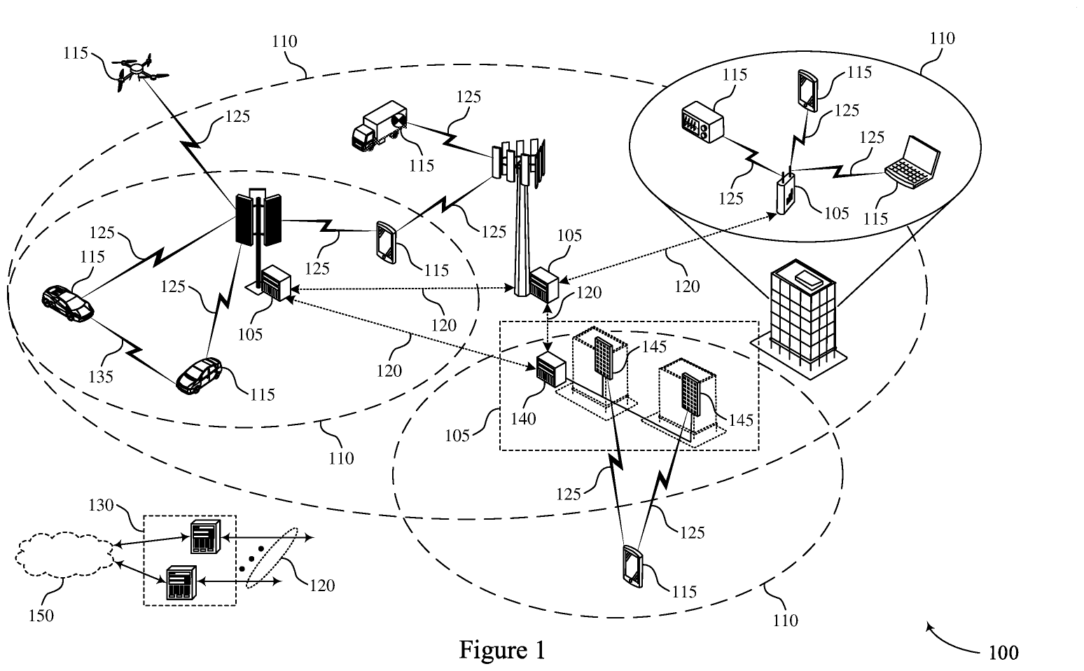

FIG. 1 illustrates an example of a wireless communications system 100 that supports common beam indication techniques for multi-beam operation in accordance with aspects of the present disclosure. The wireless communications system 100 may include one or more BSs 105, one or more UEs 115, and a core network 130. In some implementations, the wireless communications system 100 may be a Long Term Evolution (LTE) network, an LTE-Advanced (LTE-A) network, an LTE-A Pro network, or a New Radio (NR) network. In some implementations, the wireless communications system 100 may support enhanced broadband communications, ultra-reliable (such as mission critical) communications, low latency communications, communications with low-cost and low-complexity devices, or any combination thereof.

The BSs 105 may be dispersed throughout a geographic area to form the wireless communications system 100 and may be devices in different forms or having different capabilities. The BSs 105 and the UEs 115 may wirelessly communicate via one or more communication links 125. Each BS 105 may provide a coverage area 110 over which the UEs 115 and the BS 105 may establish one or more communication links 125. The coverage area 110 may be an example of a geographic area over which a BS 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the BSs 105, or network equipment (such as core network nodes, relay devices, integrated access and backhaul (IAB) nodes, or other network equipment), as shown in FIG. 1.

The BSs 105 may communicate with the core network 130, or with one another, or both. For example, the BSs 105 may interface with the core network 130 through one or more backhaul links 120 (such as via an S1, N2, N3, or another interface). The BSs 105 may communicate with one another over the backhaul links 120 (such as via an X2, Xn, or other interface) either directly (such as directly between BSs 105), or indirectly (such as via core network 130), or both. In some implementations, the backhaul links 120 may be or include one or more wireless links.

One or more of the BSs 105 described herein may include or may be referred to by a person having ordinary skill in the art as a base transceiver station, a radio BS, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” also may be referred to as a unit, a station, a terminal, or a client, among other examples. A UE 115 also may include or may be referred to as a personal electronic device such as a cellular phone, a personal digital assistant (PDA), a tablet computer, a laptop computer, or a personal computer. In some implementations, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the BSs 105 and the network equipment including macro eNBs or gNBs, small cell eNBs or gNBs, or relay BSs, among other examples, as shown in FIG. 1.

The UEs 115 and the BSs 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (such as a bandwidth part (BWP)) that is operated according to one or more physical layer channels for a given radio access technology (such as LTE, LTE-A, LTE-A Pro, NR). Each physical layer channel may carry acquisition signaling (such as synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (such as in a carrier aggregation configuration), a carrier also may have acquisition signaling or control signaling that coordinates operations for other carriers. A carrier may be associated with a frequency channel (such as an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (such as of the same or a different radio access technology).

The communication links 125 shown in the wireless communications system 100 may include uplink transmissions from a UE 115 to a BS 105, or downlink transmissions from a BS 105 to a UE 115. Carriers may carry downlink or uplink communications (such as in an FDD mode) or may be configured to carry downlink and uplink communications (such as in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (such as 1.4, 3, 5, 10, 15, 20, 40, or 80 megahertz (MHz)). Devices of the wireless communications system 100 (such as the BSs 105, the UEs 115, or both) may have hardware configurations that support communications over a particular carrier bandwidth or may be configurable to support communications over one of a set of carrier bandwidths. In some implementations, the wireless communications system 100 may include BSs 105 or UEs 115 that support simultaneous communications via carriers associated with multiple carrier bandwidths. In some implementations, each served UE 115 may be configured for operating over portions (such as a sub-band, a BWP) or all of a carrier bandwidth.

Signal waveforms transmitted over a carrier may be made up of multiple subcarriers (such as using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (such as a duration of one modulation symbol) and one subcarrier, where the symbol period and subcarrier spacing are inversely related. The number of bits carried by each resource element may depend on the modulation scheme (such as the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (such as spatial layers or beams), and the use of multiple spatial layers may further increase the data rate or data integrity for communications with a UE 115.

One or more numerologies for a carrier may be supported, where a numerology may include a subcarrier spacing (h f) and a cyclic prefix. A carrier may be divided into one or more BWPs having the same or different numerologies. In some implementations, a UE 115 may be configured with multiple BWPs. In some implementations, a single BWP for a carrier may be active at a given time and communications for the UE 115 may be restricted to one or more active BWPs.

The time intervals for the BSs 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (such as 10 milliseconds (ms)). Each radio frame may be identified by a system frame number (SFN) (such as ranging from 0 to 1023).

Each frame may include multiple consecutively numbered subframes or slots, and each subframe or slot may have the same duration. In some implementations, a frame may be divided (such as in the time domain) into subframes, and each subframe may be further divided into a number of slots. Alternatively, each frame may include a variable number of slots, and the number of slots may depend on subcarrier spacing. Each slot may include a number of symbol periods (such as depending on the length of the cyclic prefix prepended to each symbol period). In some wireless communications systems 100, a slot may further be divided into multiple mini-slots containing one or more symbols. Excluding the cyclic prefix, each symbol period may contain one or more (such as N f) sampling periods. The duration of a symbol period may depend on the subcarrier spacing or frequency band of operation.

A subframe, a slot, a mini-slot, or a symbol may be the smallest scheduling unit (such as in the time domain) of the wireless communications system 100 and may be referred to as a transmission time interval (TTI). In some implementations, the TTI duration (such as the number of symbol periods in a TTI) may be variable. Additionally, or alternatively, the smallest scheduling unit of the wireless communications system 100 may be dynamically selected (such as in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (such as a control resource set (CORESET)) for a physical control channel may be defined by a number of symbol periods and may extend across the system bandwidth or a subset of the system bandwidth of the carrier. One or more control regions (such as CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (such as control channel elements (CCEs)) associated with encoded information for a control information format having a given payload size. Search space sets may include common search space sets configured for sending control information to multiple UEs 115 and UE-specific search space sets for sending control information to a specific UE 115.

Each BS 105 may provide communication coverage via one or more cells, for example a macro cell, a small cell, a hot spot, or other types of cells, or any combination thereof. The term “cell” may refer to a logical communication entity used for communication with a BS 105 (such as over a carrier) and may be associated with an identifier for distinguishing neighboring cells (such as a physical cell identifier (PCID), a virtual cell identifier (VCID), or others). In some implementations, a cell also may refer to a geographic coverage area 110 or a portion of a geographic coverage area 110 (such as a sector) over which the logical communication entity operates. Such cells may range from smaller areas (such as a structure, a subset of structure) to larger areas depending on various factors such as the capabilities of the BS 105. For example, a cell may be or include a building, a subset of a building, or exterior spaces between or overlapping with geographic coverage areas 110, among other examples.

A macro cell generally covers a relatively large geographic area (such as several kilometers in radius) and may allow unrestricted access by the UEs 115 with service subscriptions with the network provider supporting the macro cell. A small cell may be associated with a lower-powered BS 105, as compared with a macro cell, and a small cell may operate in the same or different (such as licensed, unlicensed) frequency bands as macro cells. Small cells may provide unrestricted access to the UEs 115 with service subscriptions with the network provider or may provide restricted access to the UEs 115 having an association with the small cell (such as the UEs 115 in a closed subscriber group (CSG), the UEs 115 associated with users in a home or office). ABS 105 may support one or multiple cells and also may support communications over the one or more cells using one or multiple component carriers.

In some implementations, a carrier may support multiple cells, and different cells may be configured according to different protocol types (such as MTC, narrowband IoT (NB-IoT), enhanced mobile broadband (eMBB)) that may provide access for different types of devices.

In some implementations, a BS 105 may be movable and therefore provide communication coverage for a moving geographic coverage area 110. In some implementations, different geographic coverage areas 110 associated with different technologies may overlap, but the different geographic coverage areas 110 may be supported by the same BS 105. In other examples, the overlapping geographic coverage areas 110 associated with different technologies may be supported by different BSs 105. The wireless communications system 100 may include, for example, a heterogeneous network in which different types of the BSs 105 provide coverage for various geographic coverage areas 110 using the same or different radio access technologies.

The wireless communications system 100 may support synchronous or asynchronous operation. For synchronous operation, the BSs 105 may have similar frame timings, and transmissions from different BSs 105 may be approximately aligned in time. For asynchronous operation, the BSs 105 may have different frame timings, and transmissions from different BSs 105 may, in some implementations, not be aligned in time. The techniques described herein may be used for either synchronous or asynchronous operations.

Some UEs 115, such as MTC or IoT devices, may be low cost or low complexity devices and may provide for automated communication between machines (such as via Machine-to-Machine (M2M) communication). M2M communication or MTC may refer to data communication technologies that allow devices to communicate with one another or a BS 105 without human intervention. In some implementations, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (such as a mode that supports one-way communication via transmission or reception, but not transmission and reception simultaneously). In some implementations, half-duplex communications may be performed at a reduced peak rate. Other power conservation techniques for the UEs 115 include entering a power saving deep sleep mode when not engaging in active communications, operating over a limited bandwidth (such as according to narrowband communications), or a combination of these techniques. For example, some UEs 115 may be configured for operation using a narrowband protocol type that is associated with a defined portion or range (such as set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (such as mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some implementations, a UE 115 also may be able to communicate directly with other UEs 115 over a device-to-device (D2D) communication link 135 (such as using a peer-to-peer (P2P) or D2D protocol). One or more UEs 115 utilizing D2D communications may be within the geographic coverage area 110 of a BS 105. Other UEs 115 in such a group may be outside the geographic coverage area 110 of a BS 105 or be otherwise unable to receive transmissions from a BS 105. In some implementations, groups of the UEs 115 communicating via D2D communications may utilize a one-to-many (1:M) system in which each UE 115 transmits to every other UE 115 in the group. In some implementations, a BS 105 facilitates the scheduling of resources for D2D communications. In other cases, D2D communications are carried out between the UEs 115 without the involvement of a BS 105.

In some systems, the D2D communication link 135 may be an example of a communication channel, such as a sidelink communication channel, between vehicles (such as UEs 115). In some implementations, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some implementations, vehicles in a V2X system may communicate with roadside infrastructure, such as roadside units, or with the network via one or more network nodes (such as BSs 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (such as a mobility management entity (MME), an access and mobility management function (AMF)) and at least one user plane entity that routes packets or interconnects to external networks (such as a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the BSs 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a BS 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or BS 105 may be distributed across various network devices (such as radio heads and ANCs) or consolidated into a single network device (such as a BS 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (such as less than 100 kilometers) compared to transmission using the smaller frequencies and longer waves of the high frequency (HF) or very high frequency (VHF) portion of the spectrum below 300 MHz.

The wireless communications system 100 also may operate in a super high frequency (SHF) region using frequency bands from 3 GHz to 30 GHz, also known as the centimeter band, or in an extremely high frequency (EHF) region of the spectrum (such as from 30 GHz to 300 GHz), also known as the millimeter band. In some implementations, the wireless communications system 100 may support millimeter wave (mmW) communications between the UEs 115 and the BSs 105, and EHF antennas of the respective devices may be smaller and more closely spaced than UHF antennas. In some implementations, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the BSs 105 and the UEs 115 may employ carrier sensing for collision detection and avoidance. In some implementations, operations in unlicensed bands may be based on a carrier aggregation configuration in conjunction with component carriers operating in a licensed band (such as LAA). Operations in unlicensed spectrum may include downlink transmissions, uplink transmissions, P2P transmissions, or D2D transmissions, among other examples.

ABS 105 or a UE 115 may be equipped with multiple antennas, which may be used to employ techniques such as transmit diversity, receive diversity, multiple-input multiple-output (MIMO) communications, or beamforming. The antennas of a BS 105 or a UE 115 may be located within one or more antenna arrays or antenna panels, which may support MIMO operations or transmit or receive beamforming. For example, one or more BS antennas or antenna arrays may be co-located at an antenna assembly, such as an antenna tower. In some implementations, antennas or antenna arrays associated with a BS 105 may be located in diverse geographic locations. A BS 105 may have an antenna array with a number of rows and columns of antenna ports that the BS 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

The BSs 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (such as the same codeword) or different data streams (such as different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which also may be referred to as spatial filtering, directional transmission, or directional reception, is a signal processing technique that may be used at a transmitting device or a receiving device (such as a BS 105, a UE 115) to shape or steer an antenna beam (such as a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (such as with respect to the antenna array of the transmitting device or receiving device, or with respect to some other orientation).

A BS 105 or a UE 115 may use beam sweeping techniques as part of beam forming operations. For example, a BS 105 may use multiple antennas or antenna arrays (such as antenna panels) to conduct beamforming operations for directional communications with a UE 115. Some signals (such as synchronization signals, reference signals, beam selection signals, or other control signals) may be transmitted by a BS 105 multiple times in different directions. For example, the BS 105 may transmit a signal according to different beamforming weight sets associated with different directions of transmission. Transmissions in different beam directions may be used to identify (such as by a transmitting device, such as a BS 105, or by a receiving device, such as a UE 115) a beam direction for later transmission or reception by the BS 105.

Some signals, such as data signals associated with a particular receiving device, may be transmitted by a BS 105 in a single beam direction (such as a direction associated with the receiving device, such as a UE 115). In some implementations, the beam direction associated with transmissions along a single beam direction may be determined based on a signal that was transmitted in one or more beam directions. For example, a UE 115 may receive one or more of the signals transmitted by the BS 105 in different directions and may report to the BS 105 an indication of the signal that the UE 115 received with a highest signal quality or an otherwise acceptable signal quality.

In some implementations, transmissions by a device (such as by a BS 105 or a UE 115) may be performed using multiple beam directions, and the device may use a combination of digital precoding or radio frequency beamforming to generate a combined beam for transmission (such as from a BS 105 to a UE 115). The UE 115 may report feedback that indicates precoding weights for one or more beam directions, and the feedback may correspond to a configured number of beams across a system bandwidth or one or more sub-bands. The BS 105 may transmit a reference signal (such as a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (such as a multi-panel type codebook, a linear combination type codebook, a port selection type codebook). Although these techniques are described with reference to signals transmitted in one or more directions by a BS 105, a UE 115 may employ similar techniques for transmitting signals multiple times in different directions (such as for identifying a beam direction for subsequent transmission or reception by the UE 115) or for transmitting a signal in a single direction (such as for transmitting data to a receiving device).

A receiving device (such as a UE 115) may try multiple receive configurations (such as directional listening) when receiving various signals from the BS 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (such as different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some implementations, a receiving device may use a single receive configuration to receive along a single beam direction (such as when receiving a data signal). The single receive configuration may be aligned in a beam direction determined based on listening according to different receive configuration directions (such as a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer also may use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a BS 105 or a core network 130 supporting radio bearers for user plane data. At the physical layer, transport channels may be mapped to physical channels.

The UEs 115 and the BSs 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (such as using a cyclic redundancy check (CRC)), forward error correction (FEC), and retransmission (such as automatic repeat request (ARQ)). HARQ may improve throughput at the MAC layer in poor radio conditions (such as low signal-to-noise conditions). In some implementations, a device may support same-slot HARQ feedback, where the device may provide HARQ feedback in a specific slot for data received in a previous symbol in the slot. In other cases, the device may provide HARQ feedback in a subsequent slot, or according to some other time interval.

In some implementations, a UE 115 may receive an indication of a TCI or a TCI state from a BS 105. The indication may include one or more beam configurations or beam configuration states, respectively, such as a quasi-collocation (QCL) relationship (such as one or more QCL rules) between a downlink reference signal and DMRS ports. The BS 105 may indicate a TCI state for downlink communications from the BS 105 to the UE 115. However, the BS 105 and the UE 115 may manage uplink communications separately, which may use additional processing time as well as signaling and network overhead. Thus, the UE 115 and the BS 105 may reduce signaling and network overhead (such as overhead related to beam indication) by using a single TCI state, which may be referred to as a joint downlink and uplink TCI state, to indicate QCL rules for communication using one or more common beams in both the downlink and uplink direction.

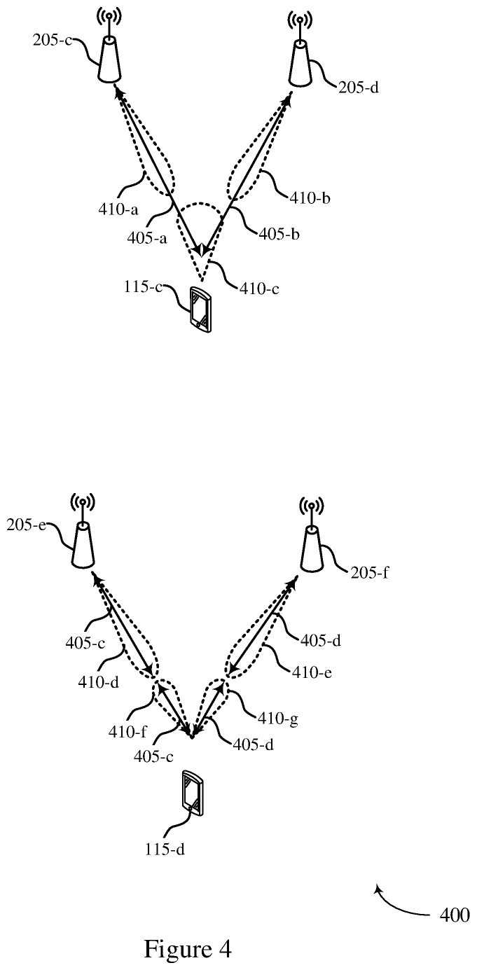

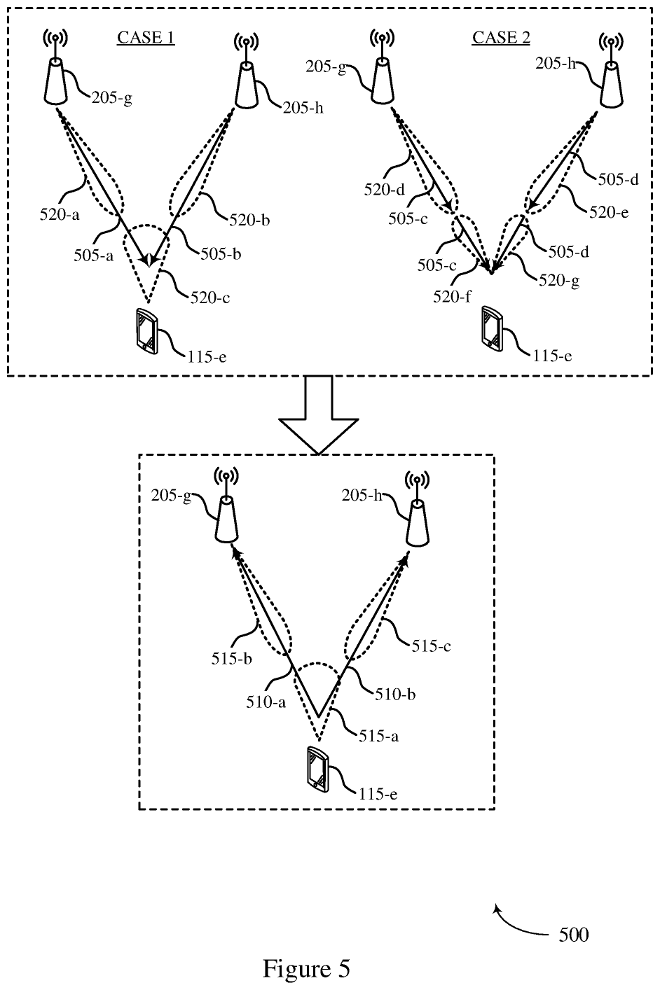

In some implementations, the UE 115 may be capable of performing a multi-beam operation, such as a simultaneous multi-beam reception operation, a simultaneous multi-beam transmission operation, or both, which is described in further detail with respect to FIGS. 4 and 5. In some implementations, the UE 115 may receive a common beam indication for both uplink transmission and downlink reception.

However, in some implementations, the UE 115 may support a number of simultaneous transmit beams or a number of simultaneous receive beams. The UE 115 may transmit a report to a BS 105 or a TRP including the number of simultaneous transmit beams, the number of simultaneous receive beams, or both supported by the UE 115. In some implementations, the UE 115 may receive a common beam indication for downlink reception and uplink transmission. The common beam indication may include one or more TCI states, such as a pair of TCI states, which the UE 115 may use for downlink reception and uplink transmission. In some implementations, the UE 115 may apply one or more QCL rules, or assumptions, a spatial filter, or both, of the indicated TCI states for downlink reception and for uplink transmission. The UE 115 may select a TCI state, or multiple TCI states, of the one or more TCI states as an uplink component of a common beam based on a selection criterion, which may include one or more parameters associated with the common beam, and the number of simultaneous transmit beams supported by the UE 115. In some implementations, the UE 115 may be configured with different multiplexing modes (such as an SDM mode, a TDM mode, an FDM mode, an SFN mode, or the like) for downlink multi-beam reception and uplink multi-beam transmission, which may be referred to as a hybrid downlink and uplink mode.

In some implementations, if the common beam indication includes an indication of one or more TCI states, the UE 115 may apply the indicated TCI states based on an order of downlink reception occasions and uplink transmission occasions. For example, if the common beam indication includes an indication of one or more TCI states, such as a pair of TCI sates, the UE 115 may perform pathloss association for one or more transmission occasions or may apply a timing advance of the TCI states for uplink transmission occasions. In some implementations, the UE 115 and TRP may communicate based on the UE 115 applying the one or more TCI states for an uplink transmission, a downlink reception, or both using the common beam. The communications may include an uplink transmission, a downlink reception, or both.

In some implementations, a UE 115 may receive control signaling, which may enable a group-based beam reporting mode at the UE 115. Additionally, or alternatively, the UE 115 may receive an indicator, such as a group-based beam reporting configuration, that UE 115 may use to determine whether group-based downlink beam reporting may be applied for an uplink simultaneous transmission. In some implementations, the UE 115 may selectively enable or disable the group-based beam reporting configuration based on receiving the group-based beam reporting control signaling.

In some implementations, if group-based beam reporting is enabled for uplink at the UE 115, the UE 115 may report one or more reference signal resource indices for each report setting in a single reporting instance. In some implementations, the UE 115 may report one or more RSRP values for each reference signal resource. The UE 115 may report RSRP values differentially for the one or more reference signals. In some implementations, the UE 115 may transmit the reference signals over the reference signal resources simultaneously with multiple simultaneous spatial domain transmit filters. In some implementations, the UE 115 and the TRP may communicate based on the UE 115 enabling or disabling group-based beam reporting for an uplink transmission, a downlink reception, or both.

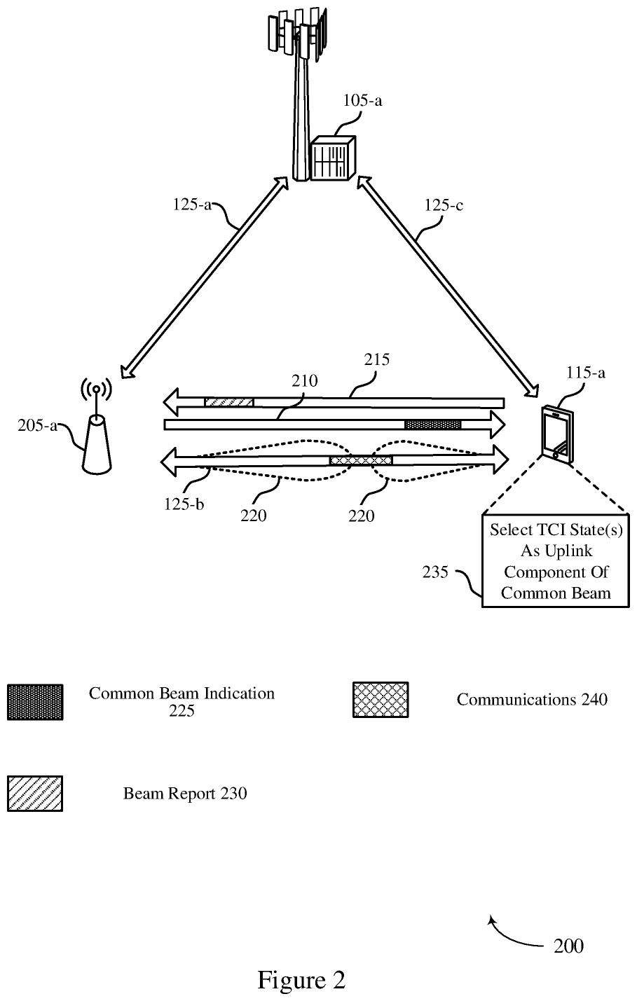

FIG. 2 illustrates an example of a communication technique to indicate a common beam for multi-beam operation. In some implementations, the wireless communications system 200 may implement aspects of the wireless communications system 100 and may include UE 115-a, BS 105-a, and communication link 125-a through communication link 125-c, which may be examples of a UE 115, a BS 105, and communication links 125 as described with reference to FIG. 1. In some implementations, one or more TRPs 205, such as TRP 205-a, may be operating as a BS 105, a network node, or both. For example, TRP 205-a may communicate with BS 105-a via communication link 125-a to relay signals between UE 115-a and BS 105-a (such as via communication link 125-b, downlink control link 210, uplink control link 215, or both) or may independently transmit or receive signals from UE 115-a. Similarly, BS 105-a may directly communicate with UE 115-a via communication link 125-c. In some implementations, UE 115-a may transmit control information via uplink control link 215 to TRP 205-a that indicates a number of simultaneous transmit beams supported by UE 115-a and may receive a common beam indication from TRP 205-a via downlink control link 210 for communicating via communication link 125-b.

In some implementations, UE 115-a may receive an indication of a TCI or a TCI state from BS 105-a (such as included in a downlink control information (DCI) message). The indication may include one or more beam configurations or beam configuration states, respectively, such as a QCL relationship between a downlink reference signal and demodulation reference signal (DMRS) ports. For example, the TCI state may include one or more QCL rules, which also may be referred to as an assumption, where a rule may associate a reference signal (such as a synchronization signal, such as a synchronization signal block (SSB); a CSI-RS; a positioning reference signal (PRS); or other reference signal) with a channel property (such as a Doppler shift; a Doppler spread; an average delay; a delay spread; one or more spatial parameters, such as a spatial filter; or other properties). There may be different types of QCL (such as QCL-TypeA, QCL-TypeB, QCL-TypeC, or QCL-TypeD), where each type may be based on different sets of QCL rules. BS 105-a may indicate a TCI state for downlink communications from BS 105-a to UE 115-a. However, BS 105-a and UE 115-a may manage uplink communications separately, which may use additional processing time as well as signaling and network overhead. Thus, UE 115-a and BS 105-a may reduce signaling and network overhead (such as overhead related to beam indication) by using a single TCI state, which may be referred to as a joint downlink and uplink TCI state, to indicate QCL rules for communication using one or more common beams 220 in both the downlink and uplink direction.

In some implementations, UE 115-a may efficiently perform downlink and uplink beam management by reducing latency and signaling overhead for inter-cell mobility (such as for intra-centric and Layer 1 (L1) or Layer 2 (L2)-centric inter-cell mobility), for a relatively large number of configured TCI states, or both. For example, UE 115-a may perform a multi-beam operation in a frequency range, such as Frequency Range 2 (FR2) or Frequency Range 1 (FR1), using a common beam 220 for data and control signaling in both the downlink and the uplink direction (such as for intra-band carrier aggregation with a unified TCI framework for downlink and uplink beam indication). The unified TCI framework may indicate a TCI to be applicable to at least one downlink channel and at least one uplink channel. Additionally, or alternatively, UE 115-a may identify and specify features (such as by considering uplink coverage loss mitigation due to maximum permissible exposure (MPE)) to facilitate uplink beam selection based on an uplink beam indication with the unified TCI framework for uplink fast panel selection if UE 115-a is equipped with multiple antenna panels.

In some implementations, UE 115-a may be capable of performing a multi-beam operation, such as a simultaneous multi-beam reception operation, a simultaneous multi-beam transmission operation, or both, which is described in further detail with respect to FIGS. 4 and 5. The multi-beam operation may be referred to as group-based beam reporting, which may be configured, or enabled, at UE 115-a (such as via a higher layer parameter, groupBasedBeamReporting in control signaling). UE 115-a may update one or more measurements for a number of reference signal resources (such as no more than 64 CSI-RS resources, SSB resources, or both) and may report indicators, such as a CSI-RS indicator (CRI) or an SSB resource indicator (SSBRI), based on receiving the reference signals simultaneously with a single spatial domain receive filter, with multiple simultaneous spatial domain receive filters, or both. In some implementations, UE 115-a may receive a common beam indication 225 for both uplink transmission and downlink reception. However, the common beam indication 225 may not account for multi-beam operation at UE 115-a. That is, if the common beam indication 225 signals a single common beam, UE 115-a may not know which of the supported beams to use for uplink communications (such as if UE 115-a is capable of a simultaneous multi-beam reception operation but not capable of a simultaneous multi-beam transmission operation). Additionally, BS 105-a or TRP 205-a may not be aware of the capability of UE 115-a to support a number of receive beams (such as for a single beam reception operation or a multi-beam reception operation), which may cause inefficient resource utilization as well as signaling latency due to ambiguity in an uplink beam indication procedure.

In some implementations, UE 115-a may support a number of simultaneous transmit beams and a number of simultaneous receive beams. For example, UE 115-a may be capable of multi-beam reception in the downlink direction and single beam transmission in the uplink direction. That is, UE 115-a may receive one or more data transmissions using multiple receive beams and may transmit one or more data transmissions using a single transmit beam. UE 115-a may transmit a report to BS 105-a or TRP 205-a, such as a beam report 230 to TRP 205-a via uplink control link 215, including the number of simultaneous transmit beams, the number of simultaneous receive beams, or both supported by UE 115-a.

In some implementations, UE 115-a may be enabled with a common beam indication 225 for downlink reception and uplink transmission. For example, UE 115-a may receive control signaling including the common beam indication 225 from TRP 205-a via downlink control link 210, from BS 105-a via communication link 125-c, or both. The control signaling may be indicated via RRC signaling, a MAC-CE, or a DCI message. The common beam indication 225 may include an indication of one or more common beams 220, which UE 115-a may use to receive a downlink transmission and transmit an uplink transmission. For example, the common beam indication 225 may include one or more TCI states, such as a pair of TCI states, UE 115-a uses for downlink reception and uplink transmission. Each TCI state may be applicable to at least one downlink channel and at least one uplink channel. The TCI state may include at least one source reference signal to provide a reference for determining a QCL relationship for a downlink channel and a spatial filter for an uplink channel. For example, the source reference signal may provide common QCL information for UE-dedicated reception on PDSCH and a portion (such as all or a subset) of CORESETs in a serving cell. The source reference signal also may provide a reference for determining one or more common uplink transmit spatial filters for a dynamic-grant, a configured-grant, or both. The common uplink transmit spatial filters may be based on a PUSCH or based on a portion (such as all or a subset) of dedicated PUCCH resources in the serving cell. The TCI state also may be referred to as a unified TCI state or joint TCI state for downlink and uplink.

In some implementations, UE 115-a may apply QCL rules, assumptions, or one or more spatial filters, of the indicated TCI states for downlink reception (such as a physical downlink control channel (PDCCH), a physical downlink shared channel (PDSCH), CSI-RS, or the like) and for uplink transmission (such as a physical uplink control channel (PUCCH), physical uplink shared channel (PUSCH), sounding reference signal (SRS), or the like). For example, UE 115-a may apply one or more QCL rules, a spatial filter, or both for a TCI state of the one or more TCI states for downlink reception and uplink transmission. Additionally, or alternatively, UE 115-a may apply one or more QCL rules, a spatial filter, or both for each TCI state of the one or more TCI states for downlink reception and uplink transmission. At 235, UE 115-a may select a TCI state, or multiple TCI states, of the one or more TCI states as an uplink component of a common beam. For example, UE 115-a may select a TCI state, or multiple TCI states, based on a selection criterion, which may include one or more parameters associated with the common beam, and the number of simultaneous transmit beams supported by UE 115-a.

In some implementations, if UE 115-a used multiple simultaneous spatial domain receive filters to receive the one or more TCI states, UE 115-a may select a single TCI state from the one or more TCI states based on one or more parameters. For example, UE 115-a may select the TCI state based on an index or order in the common beam indication 225 (such as the first TCI state included in the common beam indication 225), a TCI state identifier (such as the TCI state with the lowest identifier), an SSB identifier (such as the TCI state with QCL rules for the lowest SSB identifier), or a combination. In some other implementations, UE 115-a may select the TCI state associated with a downlink reception occasion based on a CORESET identifier (such as the lowest CORESET identifier), a search space identifier (such as the lowest search space identifier), a portion of a frequency domain resource allocation (such as the downlink reception occasion with the lower part of the frequency resource domain allocation), a portion of a time domain resource allocation (such as the downlink reception occasion with the first part of the time resource domain allocation), or a combination. In some other implementations, if UE 115-a used a single spatial domain receive filter to receive the one or more TCI states, UE 115-a may apply the one or more QCL rules, the spatial filter, or both for each TCI state of the one or more TCI states, or a portion of the one or more TCI states, for downlink reception and uplink transmission.

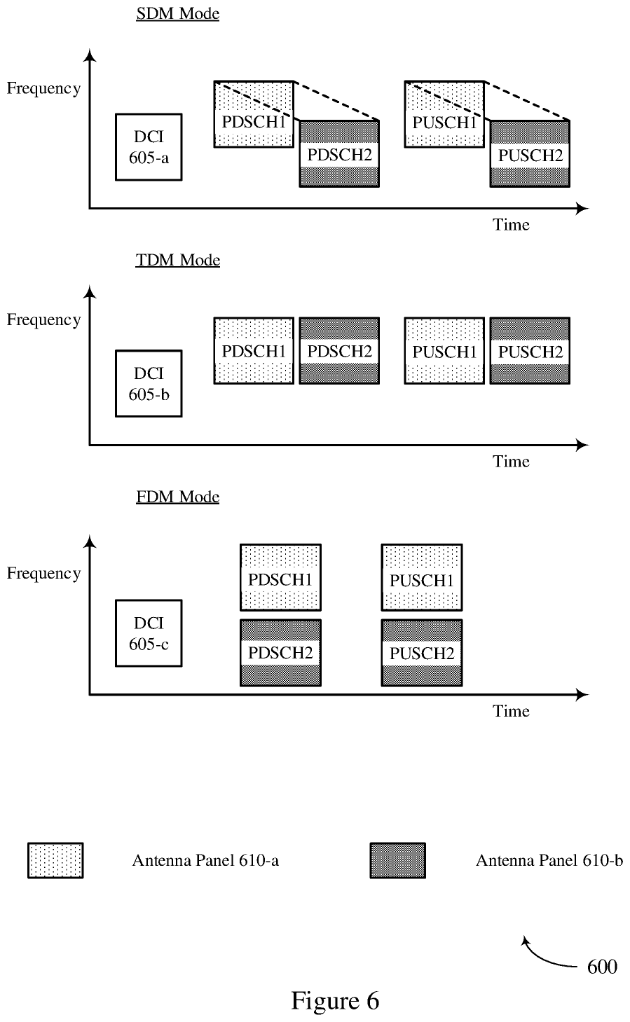

In some implementations, UE 115-a may be configured with different multiplexing modes (such as an SDM mode, a TDM mode, an FDM mode, an SFN mode, or the like) for downlink multi-beam reception and uplink multi-beam transmission that share one or more common beams 220 included in the common beam indication 225, which is described in further detail with respect to FIGS. 6-8. If the downlink multi-beam reception and uplink multi-beam transmission operations operate with different multiplexing modes, UE 115-a may be operating in a hybrid downlink and uplink mode. For example, UE 115-a may operate in a hybrid downlink and uplink mode if UE 115-a performs a multi-beam reception operation according to an SDM technique and a multi-beam transmission operation according to a TDM technique.

In some implementations, if the common beam indication 225 includes an indication of one or more TCI states, UE 115-a may apply the indicated TCI states based on an order of downlink reception occasions (such as for PDCCH, PDSCH, CSI-RS, or the like) and uplink transmission occasions (such as for PUCCH, PUSCH, SRS, or the like). For example, if the common beam indication 225 indicates a pair of TCI states, UE 115-a may apply the first TCI state of the pair for a first downlink reception or uplink transmission occasion and a second TCI state of the pair for a second downlink reception or uplink transmission occasion, where the first and second downlink reception or uplink transmission occasions are identified by one or more parameters (such as a CORESET, a search space identifier, a frequency domain resource allocation, a time domain resource allocation, or a combination).

In some implementations, if the common beam indication 225 includes an indication of one or more TCI states, such as a pair of TCI sates, UE 115-a may perform pathloss association for one or more transmission occasions. For example, UE 115-a may apply a reference signal associated with a first TCI state of the pair of TCI states as a pathloss reference signal for a first uplink transmission occasion and a reference signal associated with a second TCI state of the pair of TCI states as the pathloss reference signal for a second uplink transmission occasion. In some other implementations, if the common beam indication 225 includes an indication of one or more TCI states, such as a pair of TCI sates, UE 115-a may apply a timing advance of each TCI state for one or more transmission occasions. For example, UE 115-a may apply a timing advance of a first TCI state of the pair of TCI states for a first uplink transmission occasion and the timing advance of the second TCI state for a second uplink transmission occasion. In some implementations, the order the one or more TCI states may be applied for downlink reception may be based on a TCI identifier, an SSB with QCL rules for the indicated TCI states, a CORESET identifier, a search space identifier, a portion of a frequency domain resource allocation, a portion of a time domain resource allocation, or a combination. For example, the first TCI state of the pair of TCI states may have a relatively lower, or earlier, parameter, while the second TCI state of the pair of TCI states may have a relatively higher parameter.

In some implementations, UE 115-a and TRP 205-a may communicate based on UE 115-a applying the one or more TCI states for an uplink transmission, a downlink reception, or both using the common beam 220. The communications 240 may include an uplink transmission, a downlink reception, or both.

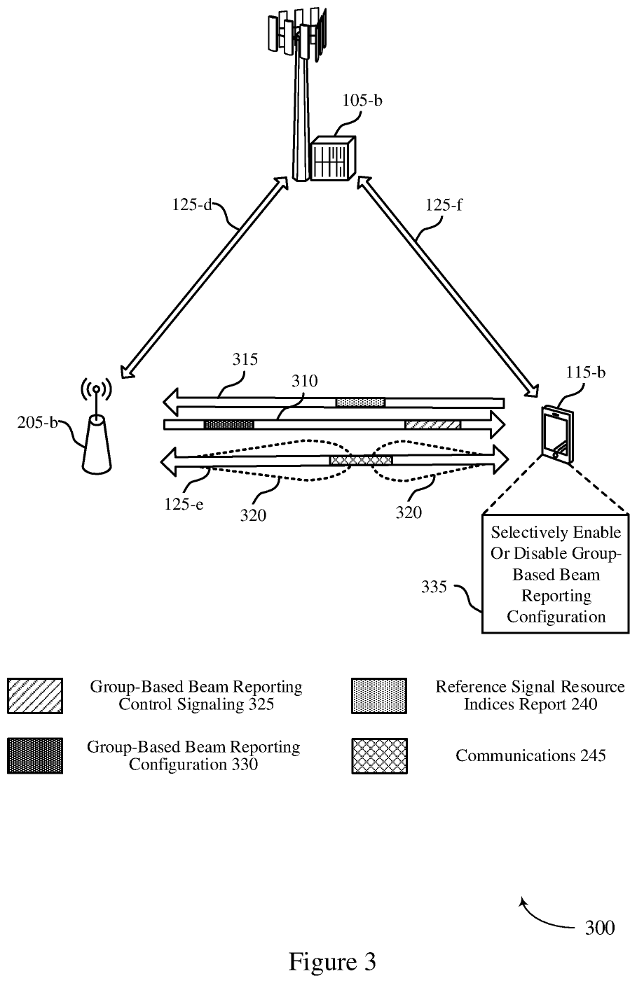

FIG. 3 illustrates an example of a communication technique to indicate a common beam for multi-beam operation. Wireless communications system 300 may implement aspects of wireless communications system 100, wireless communications system 200, or both and may include UE 115-b, BS 105-b, TRP 205-b, and communication link 125-d through communication link 125-f, which may be examples of a UE 115, a BS 105, a TRP 205, and communication links 125 as described with reference to FIGS. 1 and 2. In some implementations, one or more TRPs 205, such as TRP 205-b, may be operating as a BS 105, a network node, or both. For example, TRP 205-b may communicate with BS 105-b via communication link 125-d to relay signals between UE 115-b and BS 105-b (such as via communication link 125-e, downlink control link 310, uplink control link 315, or both) or may independently transmit or receive signals from UE 115-b. Similarly, BS 105-b may directly communicate with UE 115-b via communication link 125-f In some implementations, UE 115-b may receive control signaling from TRP 205-b via downlink control link 310 or from BS 105-b via communication link 125-f that enables a group-based beam reporting mode at UE 115-b. UE 115-b may selectively enable or disable a group-based beam reporting configuration to an uplink transmission (such as to TRP 205-b or to BS 105-b), a downlink reception (such as from TRP 205-b or from BS 105-b), or both.

In some implementations, UE 115-b may receive an indication of a TCI or a TCI state from BS 105-b. The indication may include one or more beam configurations or beam configuration states, respectively, such as a QCL relationship (such as one or more QCL rules) between a downlink reference signal and DMRS ports. BS 105-b may indicate a TCI state for downlink communications from BS 105-b to UE 115-b. However, BS 105-b and UE 115-b may manage uplink communications separately, which may use additional processing time as well as signaling and network overhead. Thus, UE 115-b and BS 105-b may reduce signaling and network overhead (such as related to beam indication) by using a single TCI state, which may be referred to as a joint downlink and uplink TCI state, to indicate QCL rules for communication using one or more common beams 220 in both the downlink and uplink direction.

In some implementations, UE 115-b may be capable of performing a multi-beam operation, such as a simultaneous multi-beam reception operation, a simultaneous multi-beam transmission operation, or both, which is described in further detail with respect to FIGS. 4 and 5. The multi-beam operation may be referred to as group-based beam reporting, which may be configured, or enabled, at UE 115-b (such as via a higher layer parameter, groupBasedBeamReporting in control signaling). UE 115-b may update one or more measurements for a number of reference signal resources (such as no more than 64 CSI-RS resources, SSB resources, or both) and may report indicators, such as a CRI or an SSBRI, based on receiving the reference signals simultaneously with a single spatial domain receive filter, with multiple simultaneous spatial domain receive filters, or both. In some implementations, UE 115-b may receive a common beam indication for both uplink transmission and downlink reception. However, the common beam indication may not account for multi-beam operation at UE 115-b. That is, if the common beam indication includes a single common beam, UE 115-b may not know which beam to use for uplink communications (such as if UE 115-b is capable of a simultaneous multi-beam reception operation but not capable of a simultaneous multi-beam transmission operation), which may cause inefficient resource utilization as well as signaling latency due to ambiguity in an uplink beam indication procedure.

In some implementations, UE 115-b may receive control signaling, such as RRC signaling, (such as from TRP 205-b, BS 105-b, or both), which may enable a group-based beam reporting mode at UE 115-b. For example, UE 115-b may receive group-based beam reporting control signaling 325 from TRP 205-b via downlink control link 310. The group-based beam reporting control signaling 325 may include a higher layer parameter, such as a groupBasedBeamReporting parameter, which may be set to enabled. Thus, UE 115-b may know to perform a multi-beam operation. Additionally, or alternatively, UE 115-b may receive an indicator, such as a group-based beam reporting configuration 330, that UE 115-b may use to determine whether group-based downlink beam reporting may be applied for an uplink simultaneous transmission. In some implementations, UE 115-b may receive group-based beam reporting configuration 330 in control signaling, such as a MAC-CE, a DCI message, RRC signaling, or the like, from TRP 205-b via downlink control link 310.

In some implementations, at 335, UE 115-b may selectively enable or disable the group-based beam reporting configuration 330 based on receiving the group-based beam reporting control signaling 325. In some implementations, TRP 205-b, BS 105-b, or both may include the indicator of the group-based beam reporting configuration 330 in a CSI report configuration, in a UE capability report, or the like to UE 115-b. The group-based beam reporting configuration 330 may indicate a single beam reception, in which the UE 115 may perform group-based beam reporting using a single receive beam or a single spatial filter. In some other implementations, the group-based beam reporting configuration 330 may indicate multi-beam reception, such as a two beam reception or a two spatial filter reception, in which UE 115-b may perform group-based beam reporting using multiple simultaneous receive beams. For example, the CSI report configuration, the UE capability report, or both may include an indicator such that if the value is 1, the beams reported by the UE may have a single receive beam, and if the value is 0, the beams reported by UE 115-b may have multiple simultaneous receive beams.

In some implementations, if group-based beam reporting is enabled at UE 115-b, UE 115-b may determine whether to perform uplink simultaneous transmission based on the number of beams reported in a group-based downlink beam reporting operation, which is described in further detail with respect to FIG. 5. For example, if UE 115-b receives an indication of two uplink beams (such as two TCIs, two spatial relation information messages, two spatial transmit filters, or the like) in a group-based downlink beam reporting procedure, UE 115-b may not expect to be indicated with an uplink simultaneous transmission (such as with two transmit precoding matrix indices (TPMIs), two transmit power controls (TPCs), two SRS resource indicators (SRIs), two phase tracking reference signals (PTRSs), or a combination for uplink).

In some implementations, if group-based beam reporting is enabled for uplink at UE 115-b (such as via a higher layer parameter, such as groupBasedBeamReportingforUL), UE 115-b may report one or more reference signal resource indices for each report setting in a single reporting instance. For example, UE 115-b may transmit a reference signal resource indices report 240 to TRP 205-b, BS 105-b, or both. In some implementations, UE 115-b may transmit the reference signal resources simultaneously with multiple simultaneous spatial domain transmit filters. In some implementations, the reference signal resource indices may be the same (such as a CRI for a CSI-RS resource, an SSBRI for an SSB block, an SRI for an SRS resource, or the like). In some other implementations, such as for downlink beam reporting, the reference signal resource indices may be different. In some implementations, UE 115-b may report one or more RSRP values for each reference signal resource. For example, UE 115-b may report RSRP values differentially for the one or more reference signals. That is, UE 115-b may report an RSRP for a first reference signal with the largest absolute value of RSRP and additional RSRPs for additional reference signals based on the absolute value of the RSRP (such as in descending order) and the difference between the RSRP for the first reference signal and the RSRP for each additional reference signal.

In some implementations, UE 115-b and TRP 205-b may communicate based on UE 115-b enabling or disabling group-based beam reporting for an uplink transmission, a downlink reception, or both. The communications 245 may include an uplink transmission, a downlink reception, or both.

FIG. 4 illustrates an example of a beam diagram 400 that supports common beam indication techniques for multi-beam operation. In some implementations, beam diagram 400 may implement aspects of wireless communication system 100 through wireless communications system 300, or a combination. For example, beam diagram 400 may be implemented by UE 115-c, UE 115-d, a BS 105, TRP 205-c through TRP 205-f, or a combination, which may be examples of UEs 115, a BS 105, or TRPs 205 as described with reference to FIGS. 1-3. In some implementations, a BS 105 or a TRP 205 may transmit control signaling to a UE 115 including information for communications via a communication link 405 and using one or more beams 410 (such as one or more transmit beams, one or more receive beams, or both, which may be associated with one or more common beams) for multi-beam operation in the uplink direction, in the downlink direction, or both. For example, the BS 105 or the TRP 205 may transmit a common beam indication, a higher layer parameter enabling group-based beam reporting, or both, as described with reference to FIGS. 2 and 3.

In some implementations, a UE 115, a BS 105, a TRP 205, or a combination may use a beam 410 for an uplink transmission, a downlink reception, or both (such as in the case of a common beam), via a communication link 405. For example, for a downlink reception at UE 115-c, TRP 205-c may transmit data or control signaling to UE 115-c using beam 410-a (such as via communication link 405-a) while TRP 205-d may transmit data or control signaling to UE 115-c using beam 410-b (such as via communication link 405-b). UE 115-c may use a single downlink beam, such as beam 410-c, or a downlink portion of a common beam, to receive the data or control signaling from TRP 205-c and TRP 205-d. In some other implementations, for a downlink reception at UE 115-d, TRP 205-e may transmit data or control signaling to UE 115-d using beam 410-d (such as via communication link 405-c) while TRP 205-f may transmit data or control signaling to UE 115-d using beam 410-e (such as via communication link 405-d). UE 115-d may use multiple downlink beams, such as beam 410-f and beam 410-g, or multiple downlink portions of one or more common beams, to receive the data or control signaling from TRP 205-e and TRP 205-f. However, the TRPs 205 (such as TRP 205-c through TRP 205-f) may be unaware of how many downlink beams the UE 115 (such as UE 115-c or UE 115-d) uses to receive the data or control signaling from each TRP 205. Thus, the UE 115 may not know how many uplink beams to use for uplink transmission to the TRPs 205 (such as because the uplink beam indication is an ambiguity).

In some implementations, the TRPs 205, a BS 105, or both may transmit control signaling to a UE 115 to enable a group-based beam reporting at the UE 115. Additionally, or alternatively, the TRPs 205, the BS 105, or both may transmit a common beam indication including a number of TCI states based on the UE 115 transmitting a beam report indicating a number of simultaneous transmit beams supported by the UE 115. Thus, the UE 115 may determine how many uplink beams, or uplink portions of a common beam, to use for communications with the TRPs 205. For example, UE 115-c may determine to use a single beam 410-c, for an uplink transmission to TRP 205-e, TRP 205-f, or both, which is described in further detail with respect to FIG. 5. In some implementations, the UE 115 may determine to perform a simultaneous uplink transmission using multiple beams 410 if group-based beam reporting is enabled at the UE 115 or if the UE 115 supports simultaneous uplink transmission. For example, UE 115-d may use beam 410-f and beam 410-g for simultaneous uplink transmissions to TRP 205-e and TRP 205-f based on transmitting a beam report indicating support for simultaneous uplink transmission (such as including a number of uplink beams supported at UE 115-d).

FIG. 5 illustrates an example of a beam diagram 500 that supports common beam indication techniques for multi-beam operation. In some implementations, beam diagram 500 may implement aspects of wireless communication system 100 through wireless communications system 300, beam diagram 400, or a combination. For example, beam diagram 500 may be implemented by UE 115-e, a BS 105, TRP 205-g, TRP 205-h, or a combination, which may be examples of a UE 115, a BS 105, or TRPs 205 as described with reference to FIGS. 1-3. In some implementations, a BS 105 or a TRP 205 may transmit control signaling to a UE 115 including information for communications via a communication link (such as a downlink communication link 505, an uplink communication link 510, or both) and using one or more beams for multi-beam operation in the uplink direction, in the downlink direction, or both. For example, the BS 105 or the TRP 205 may transmit a common beam indication, a higher layer parameter enabling group-based beam reporting, or both, as described with reference to FIGS. 2 and 3.

In some implementations, a UE 115, a BS 105, a TRP 205, or a combination may use an uplink beam 515, or an uplink portion of a common beam, for an uplink transmission, a downlink beam 520, or a downlink portion of a common beam, for downlink reception, or both. For example, for a downlink reception at UE 115-e in Case 1, TRP 205-g may transmit data or control signaling to UE 115-e using downlink beam 520-a (such as via downlink communication link 505-a) while TRP 205-h may transmit data or control signaling to UE 115-e using downlink beam 520-b (such as via downlink communication link 505-b). UE 115-e may use a single downlink beam 520, such as downlink beam 520-c, or a downlink portion of a common beam, to receive the data or control signaling from TRP 205-g and TRP 205-h. In some other implementations, for a downlink reception at UE 115-e in Case 2, TRP 205-g may transmit data or control signaling to UE 115-e using downlink beam 520-d (such as via downlink communication link 505-c) while TRP 205-h may transmit data or control signaling to UE 115-e using downlink beam 520-e (such as via downlink communication link 505-d). UE 115-e may use multiple downlink beams 520, such as downlink beam 520-f and downlink beam 520-g, or multiple downlink portions of one or more common beams, to receive the data or control signaling from TRP 205-g and TRP 205-h. However, the TRPs 205 (such as TRP 205-g and TRP 205-h) may be unaware of how many downlink beams the UE 115 uses to receive the data or control signaling from each TRP 205. Thus, the UE 115 may not know how many uplink beams to use for uplink transmission to the TRPs 205 (such as because the uplink beam indication is an ambiguity).

In some implementations, the TRPs 205, a BS 105, or both may transmit control signaling to a UE 115 to enable a group-based beam reporting at the UE 115. Additionally, or alternatively, the TRPs 205, the BS 105, or both may transmit a common beam indication including a number of TCI states based on the UE 115 transmitting a beam report indicating a number of simultaneous transmit beams supported by the UE 115. Thus, the UE 115 may determine how many uplink beams, or uplink portions of a common beam, to use for communications with the TRPs 205. For example, UE 115-e may determine to use a single uplink beam 515-a, for an uplink transmission to TRP 205-g via uplink communication link 510-a, TRP 205-h via uplink communication link 510-b, or both. In some implementations, if the group-based beam reporting is enabled at the UE 115, the UE 115 may be indicated with multiple uplink beams 515. However, if the indication is included in a group-based downlink beam reporting operation, the UE 115 may not expect to be indicated with an uplink simultaneous transmission. For example, if UE 115-e receives an indication of multiple uplink beams 515, UE 115-e may expect to perform an uplink transmission using a single uplink beam 515, such as uplink beam 515-a. In some implementations, TRP 205-g may use uplink beam 515-b to receive the uplink transmission from UE 115-e, TRP 205-h may use uplink beam 515-c to receive the uplink transmission from UE 115-e, or both.

FIG. 6 illustrates an example of a transmission diagram 600 that supports common beam indication techniques for multi-beam operation. In some implementations, transmission diagram 600 may implement aspects of wireless communication system 100 through wireless communications system 300, beam diagram 400, beam diagram 500, or a combination thereof. For example, transmission diagram 600 may be implemented by a UE 115, a BS 105, or a TRP 205 as described with reference to FIGS. 1-5. In some implementations, a BS or a TRP may transmit control signaling to a UE including information for communications and using one or more beams for multi-beam operation in the uplink direction, in the downlink direction, or both. For example, the BS or the TRP may transmit a common beam indication, a higher layer parameter enabling group-based beam reporting, or both, as described with reference to FIGS. 2 and 3.

In some implementations, a TRP may communicate with one or more UEs using a communication scheme, such as an SDM scheme, an FDM scheme, a TDM scheme, an SFN scheme, or a combination. The TRP may coordinate a transmission of a downlink channel (such as a PDSCH, a PDCCH, or both), an uplink channel (such as a PUSCH, a PUCCH, or both). For example, an SDM scheme may involve one or more TRPs performing a joint transmission over a same resource (such as over a same set of resource elements and OFDM symbols) based on transmitting different layers, such as spatial layers, with different TCI states. In some implementations, the TRP may transmit control signaling to a UE, which may include DCI 605, such as DCI 605-a, which may indicate an SDM mode (such as indicating to the UE to operate using an SDM scheme) for a downlink multi-beam reception, an uplink multi-beam transmission, or both.

In some implementations, the TRP and the UE may communicate according to the SDM scheme in which the TRP may transmit different PDSCHs (such as a first PDSCH (PDSCH1) and a second PDSCH (PDSCH2)) and different PUSCHs (such as a first PUSCH (PUSCH1) and a second PUSCH (PUSCH2)) using different spatial layers, different antenna panels 610, or both in overlapping resource elements and symbols. In such cases, the TRP may transmit different layers with different TCI states. For example, the TRP may transmit a first layer with a TCI state for antenna panel 610-a and a second layer with a TCI state for antenna panel 610-b. The first symbol of each layer transmitted according to a different TCI state may include a DMRS.

In some other implementations, the TRP may transmit control signaling to the UE including DCI 605-b, which may indicate a TDM mode (such as indicating to the UE to operate using a TDM scheme) for a downlink multi-beam reception, an uplink multi-beam transmission, or both. In some examples of a TDM scheme, the TRP may perform joint transmissions of PDSCH1, PDSCH2, PUSCH1, and PUSCH2 over different time resources and overlapping frequency resources, such as over different sets of OFDM symbols and overlapping set of resource elements, based on transmitting different sets of time-domain resources (such as OFDM symbols, slots, or mini-slots) with different TCI states. For example, the TRP may transmit PDSCH1 and PUSCH1 with a TCI state for antenna panel 610-a and PDSCH2 and PUSCH2 with a TCI state for antenna panel 610-b. If there are more than two resources used in TDM mode, the uplink transmissions with two TCI states may be mapped with a cyclic pattern (such as PUSCH1, PUSCH2, PUSCH1, PUSCH2, and so on) or a sequential pattern (such as PUSCH1, PUSCH1, . . . PUSCH2, PUSCH2, . . . and so on).

In cases, the TRP may transmit control signaling to the UE including DCI 605-c, which may indicate an FDM mode (such as indicating to the UE to operate using an FDM scheme) for a downlink multi-beam reception, an uplink multi-beam transmission, or both. The FDM scheme may involve the TRP performing joint transmissions of PDSCH1, PDSCH2, PUSCH1, and PUSCH2 over different frequency resources and overlapping time resources, such as over different sets of resource elements but over a same set of OFDM symbols, based on transmitting different sets of frequency-domain resources (such as resource elements) with different TCI states. For example, the TRP may transmit PDSCH1 and PUSCH1 with a TCI state for antenna panel 610-a and PDSCH2 and PUSCH2 with a TCI state for antenna panel 610-b.

In some implementations, the TRP may transmit control signaling to the UE indicate an SFN mode (such as indicating to the UE to operate using an SFN scheme) for a downlink multi-beam reception, an uplink multi-beam transmission, or both. The SFN scheme, which also may be referred to as a single frequency communication scheme, may be a type of multi-TRP or single-TRP communication scheme in which downlink communication links may include the same frequency bands or channel. For example, one or more TRPs may transmit separate reference signals associated with different PDSCHs. To achieve an “SFNed” PDSCH, the TRPs may define an additional TCI state, such as a TCI state associated with an antenna panel 610, that may be used to transmit an “SFNed” reference signal associated with an “SFNed” PDSCH. The “SFNed” PDSCH may include DMRS ports and data layers that are associated with the additional TCI state. In some other implementations, the TRPs may transmit separate reference signals associated with a different PDSCH and also with a joint “SFNed” PDSCH in which each DMRS port or data layer of the “SFNed” PDSCH is associated with multiple TCI states. In other words, the TRPs may transmit reference signals in a TRP-specific or non-SFN manner while the associated DMRS and PDCCH or PDSCH from the TRPs are transmitted in an SFN manner. In some implementations, the TRPs may transmit two separate reference signals associated with a different PDSCH and also with a joint PDSCH in which each data layer of the joint PDSCH is associated with multiple TCI states while each DMRS port of the joint PDSCH is associated with a single TCI state. In other words, the TRPs may transmit reference signals and DMRS in a TRP-specific or non-SFN manner while the associated with PDSCH (such as data layers) from the TRPs may be transmitted in an SFN manner.

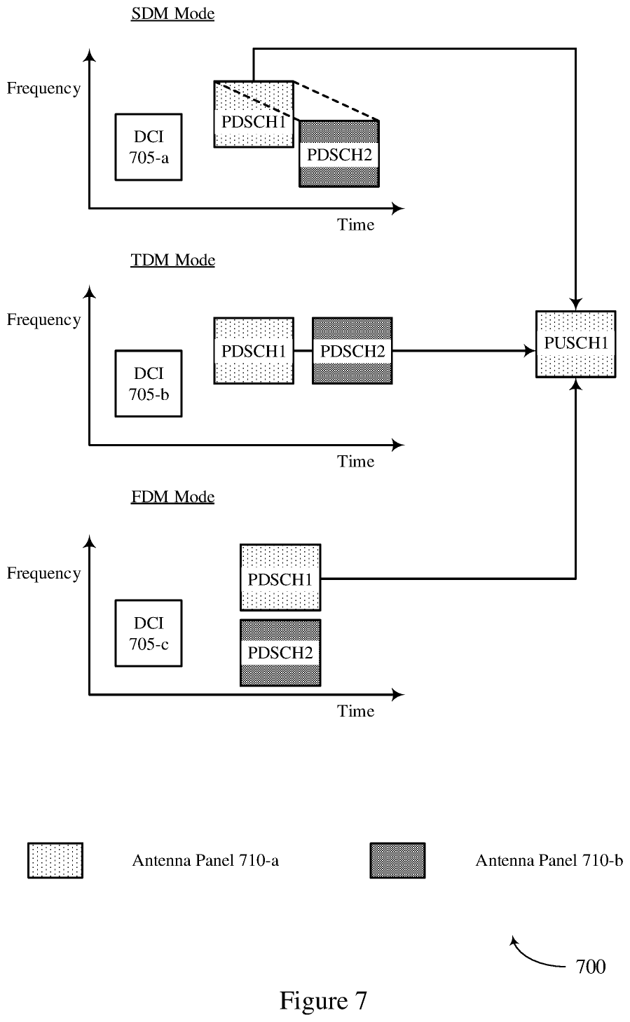

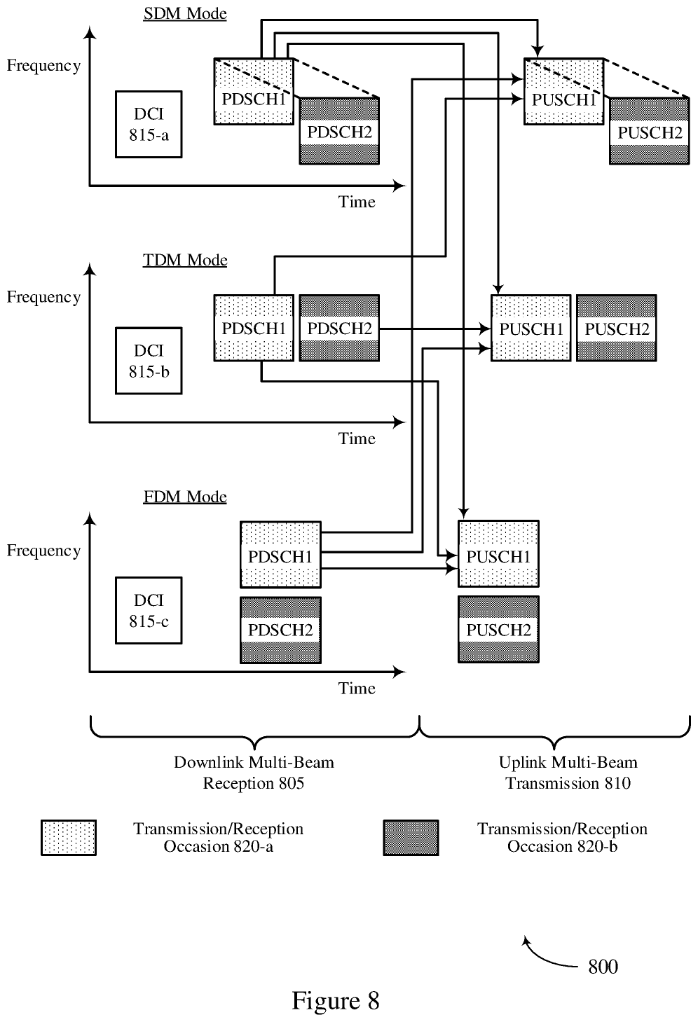

In some implementations, the UE may be configured with a multiplexing mode (such as the SDM mode, the TDM mode, the FDM mode, the SFN mode, or the like) for a downlink multi-beam reception, an uplink multi-beam transmission, or both. For example, a TRP or a BS may configure the UE via control signaling, such as a message including DCI 605, with a different multiplexing mode for the downlink multi-beam reception than for the uplink multi-beam transmission, which may be referred to as a hybrid downlink and uplink mode and is described in further detail with respect to FIG. 8. In some implementations, the downlink multi-beam reception and the uplink multi-beam transmission may share one or more common beams, which is described in further detail with respect to FIG. 7.

FIG. 7 illustrates an example of a transmission diagram 700 that supports common beam indication techniques for multi-beam operation. In some implementations, transmission diagram 700 may implement aspects of wireless communication system 100 through wireless communications system 300, beam diagram 400, beam diagram 500, transmission diagram 600, or a combination thereof. For example, transmission diagram 700 may be implemented by a UE 115, a BS 105, or a TRP 205 as described with reference to FIGS. 1-6. In some implementations, a BS or a TRP may transmit control signaling to a UE including information for communications and using one or more beams for multi-beam operation in the uplink direction, in the downlink direction, or both. For example, the BS or the TRP may transmit a common beam indication, a higher layer parameter enabling group-based beam reporting, or both, as described with reference to FIGS. 2 and 3.

In some implementations, the UE may be configured with a multiplexing mode (such as the SDM mode, the TDM mode, the FDM mode, the SFN mode, or the like) for a downlink multi-beam reception, an uplink multi-beam transmission, or both. In some implementations, the downlink multi-beam reception and the uplink multi-beam transmission may share one or more common beams. In some implementations, the UE may receive control signaling including a common beam indication, which may configure a number of receive beams for a downlink reception, a number of transmit beams for an uplink transmission, or both. For example, the common beam indication may include two receive beams. The UE may determine to use one transmit beam based on the common beam indication including the two receive beams.

In some implementations, the UE 115 may receive control signaling from a TRP or a BS, such as a message including DCI 705, indicating a mode for communicating using the number of transmit beams. For example, the UE 115 may receive DCI 705-a indicating an SDM mode, DCI 705-b indicating a TDM mode, or DCI 705-c indicating an FDM mode for an uplink transmission from the UE 115 to the TRP or the BS. In some implementations, if the UE receives DCI 705-a, the UE may perform a downlink reception (such as of PDSCH1 and PDSCH2) using two receive beams associated with antenna panel 710-a and antenna panel 710-b according to the SDM scheme. In some other implementations, if the UE receives DCI 705-b, the UE may perform a downlink reception (such as of PDSCH1 and PDSCH2) using two receive beams associated with antenna panel 710-a and antenna panel 710-b according to the TDM scheme. In some implementations, if the UE receives DCI 705-c, the UE may perform a downlink reception (such as of PDSCH1 and PDSCH2) using two receive beams associated with antenna panel 710-a and antenna panel 710-b according to the FDM scheme. In some implementations, regardless of the communication scheme, the UE may perform an uplink transmission (such as of PUSCH1) using a single receive beam associated with antenna panel 710-a.

FIG. 8 illustrates an example of a transmission diagram 800 that supports common beam indication techniques for multi-beam operation in accordance with aspects of the present disclosure. In some implementations, transmission diagram 800 may implement aspects of wireless communication system 100 through wireless communications system 300, beam diagram 400, beam diagram 500, transmission diagram 600, or a combination thereof. For example, transmission diagram 700 may be implemented by a UE 115, a BS 105, or a TRP 205 as described with reference to FIGS. 1-6. In some implementations, a BS or a TRP may transmit control signaling to a UE including information for communications and using one or more beams for multi-beam operation in the uplink direction, in the downlink direction, or both. For example, the BS or the TRP may transmit a common beam indication, a higher layer parameter enabling group-based beam reporting, or both, as described with reference to FIGS. 2 and 3.

In some implementations, the UE may be configured with a multiplexing mode (such as the SDM mode, the TDM mode, the FDM mode, the SFN mode, or the like) for a downlink multi-beam reception 805, an uplink multi-beam transmission 810, or both. For example, a TRP or a BS may configure the UE with a different multiplexing mode for the downlink multi-beam reception 805 and the uplink multi-beam transmission 810 in a hybrid downlink and uplink mode. The TRP or the BS may transmit control signaling, such as a message including DCI 815, with one of an SDM mode, a TDM mode, an FDM mode, or an SFN mode for the downlink multi-beam reception 805 and a different multiplexing mode for the uplink multi-beam transmission 810.

In some implementations, the UE may receive additional control signaling including a common beam indication, as described with reference to FIG. 2. The UE may determine to use multiple receive beams for a downlink reception and multiple uplink beams for an uplink transmission based on the common beam indication. If the UE receives DCI 815-a, the UE may perform the multi-beam downlink reception 805 based on operating according to an SDM mode and a multi-beam uplink transmission 810 based on operating according to one of a TDM mode, an FDM mode, an SFN mode, or the like. If the UE receives DCI 815-b, the UE may perform the multi-beam downlink reception 805 based on operating according to a TDM mode and a multi-beam uplink transmission 810 based on operating according to one of an SDM mode, an FDM mode, an SFN mode, or the like. If the UE receives DCI 815-c, the UE may perform the multi-beam downlink reception 805 based on operating according to an FDM mode and a multi-beam uplink transmission 810 based on operating according to one of an SDM mode, a TDM mode, an SFN mode, or the like. For example, the UE may receive PDSCH1 and PDSCH2 during the downlink multi-beam reception 805 and may transmit PUSCH1 and PDSCH2 during the uplink multi-beam transmission 810 using reception occasion 820-a and reception occasion 820-b, respectfully, and using different antenna panels according to each transmission mode as described with reference to FIG. 6. For example, the UE may determine to use a TCI state indicated in the common beam indication which has a pair of TCI states to receive PDSCH associated in reception occasion 820-a and transmit PUSCH associated in transmission occasion 820-a and may determine to use the other TCI state indicated in the common beam indication to receive PDSCH associated in reception occasion 820-b and transmit PUSCH associated in transmission occasion 820-b.

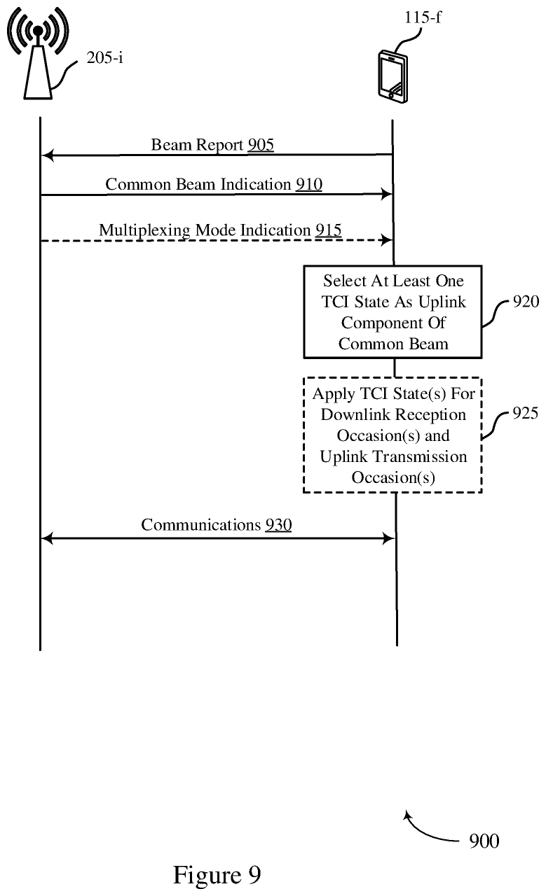

FIG. 9 illustrates an example of a process flow 900 that supports common beam indication techniques for multi-beam operation. In some implementations, process flow 900 may implement aspects of wireless communications system 100 through wireless communications system 300, beam diagram 400, beam diagram 500, transmission diagram 600 through transmission diagram 800, or a combination thereof. The process flow 900 may illustrate an example of a TRP 205, such as TRP 205-i, configuring a UE 115, such as UE 115-f, with a common beam indication based on a number of simultaneous transmit beams supported by the UE. Alternative examples of the following may be implemented, where some processes are performed in a different order than described or are not performed. In some implementations, processes may include additional features not mentioned below, or further processes may be added.

At 905, UE 115-f may transmit a beam report indicating a number of simultaneous transmit beams supported by UE 115-f. In some implementations, UE 115-f may include the beam report in control signaling, in a capability report message, or both.

At 910, UE 115-f may receive control signaling (such as RRC signaling, a MAC-CE, a DCI message, or the like) including a common beam indication for multiple TCI states. For example, UE 115-f may receive an indication of the TCI states using multiple simultaneous spatial domain receive filters. In some other implementations, UE 115-f may receive an indication of the TCI states using a single simultaneous spatial domain receive filter. In some implementations, the control signaling may include an indication of multiple TCI states, such as a pair of TCI states, for a common beam, where UE 115-f may use the common beam for downlink reception and uplink transmission.

At 915, UE 115-f may receive a multiplexing mode indication including one or more multiplexing modes (such as an SDM mode, a TDM mode, an FDM mode, an SFN mode, or the like) for an uplink transmission, a downlink reception, or both. For example, the multiplexing mode indication may include a configuration for different multiplexing modes for a downlink multi-beam reception and an uplink multi-beam transmission, which may be referred to as a hybrid downlink and uplink mode.

At 920, UE 115-f may select at least one TCI state from the multiple TCI states included in the common beam indication. UE 115-f may select the TCI state as an uplink component of a common beam based on a selection criterion for an uplink reception, a downlink transmission, or both, and the number of simultaneous transmit beams supported by UE 115-f. For example, UE 115-f may select a single TCI state based on a TCI state identifier (such as a TCI state with the lowest TCI state identifier), a TCI state index (such as a TCI state with the lowest TCI state index), an SSB identifier for the TCI state (such as a TCI state with the lowest SSB identifier), a downlink reception occasion with a lowest CORESET identifier for the TCI state, a lowest search space identifier for the TCI state, a lower portion of a frequency domain resource allocation for the TCI state, an earlier time domain resource allocation for the single TCI state, or a combination. In some other implementations, UE 115-f may select a single TCI state based on using multiple simultaneous spatial domain receive filters to receive the indication of the TCI states at 910. In some implementations, UE 115-f may select multiple TCI states based on using a single simultaneous spatial domain receive filter to receive the indication of the TCI states at 910.

At 925, UE 115-f may apply the selected TCI states, such as the pair of TCI states received at 910, for multiple downlink reception occasions, multiple uplink transmission occasions, or both based on a CORESET, a search space identifier, a frequency domain resource allocation, a time domain resource allocation, or a combination. In some implementations, such as for the pair of TCI states, UE 115-f may apply a first TCI state of the pair of TCI states to a first downlink reception occasion and a first uplink transmission occasion and a second TCI of the pair of TCI states to a second downlink reception occasion and a second uplink transmission occasion.

In some implementations, UE 115-f may apply one or more pathlosses for a reference signal associated with one or more TCI states to an uplink transmission occasion. For example, UE 115-f may apply a first pathloss corresponding to a first reference signal associated with the first TCI state of the pair of TCI states to a first uplink transmission occasion and ay apply a second pathloss corresponding to a second reference signal associated with the second TCI state of the pair of TCI states to a second uplink transmission occasion. Additionally, or alternatively, UE 115-f may apply one or more timing advances of one or more TCI states to an uplink transmission occasion. For example, UE 115-f may apply a first timing advance of the first TCI state of the pair of TCI states to a first uplink transmission occasion and a second timing advance of the second TCI state of the pair of TCI states to a second uplink transmission occasion.

At 930, UE 115-f and TRP 205-i may communicate using the common beam. For example, UE 115-f may receive signaling, such as data or control signaling, based on applying one or more QCL criteria, or QCL rules, for the TCI state selected at 920 for a downlink reception. In some other implementations, UE 115-f may transmit signaling based on applying the QCL criteria, spatial transmit filters, or both for the TCI state selected at 920 for an uplink transmission.

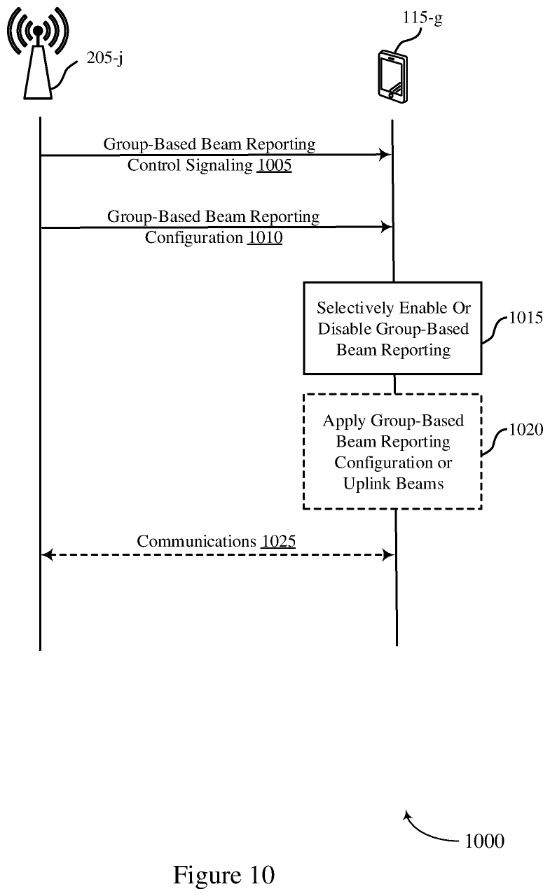

FIG. 10 illustrates an example of a process flow 1000 that supports common beam indication techniques for multi-beam operation. In some implementations, process flow 1000 may implement aspects of wireless communications system 100 through wireless communications system 300, beam diagram 400, beam diagram 500, transmission diagram 600 through transmission diagram 800, or a combination thereof. The process flow 1000 may illustrate an example of a TRP 205, such as TRP 205-j, transmit control signaling to a UE 115, such as UE 115-g, that enables a group-based beam reporting mode and indicates to the UE 115 whether to apply a group-based beam reporting configuration for uplink beam reporting. Alternative examples of the following may be implemented, where some processes are performed in a different order than described or are not performed. In some implementations, processes may include additional features not mentioned below, or further processes may be added.

At 1005, UE 115-g may receive control signaling enabling a group-based beam reporting mode at UE 115-g. For example, UE 115-g may receive an indication of one or more uplink beams including multiple TCI states, spatial relation information, multiple spatial transmit filters, or a combination.

At 1010, UE 115-g may receive additional control signaling including an indication for UE 115-g to apply a group-based beam reporting configuration for uplink beam reporting. where the indication associated with applying the group-based beam reporting configuration for the uplink beam reporting includes one or more bits in a channel state information (CSI) report, a UE capability report, or both. In some implementations, the additional control signaling may include a configuration for a single receive beam. In some other implementations, the additional control signaling may include a configuration for multiple receive beams.

At 1015, UE 115-g may selectively enable or disable the group-based beam reporting configuration to an uplink transmission, a downlink reception, or both based on the indication received at 1010. For example, UE 115-g may enable group-based beam reporting for the downlink reception based on receiving the configuration for a single receive beam. In some other implementations, UE 115-g may enable group-based beam reporting for the downlink reception based on receiving the configuration for multiple receive beams.

At 1020, UE 115-g may apply the group-based beam reporting configuration for the one or more uplink beams. In some other implementations, UE 115-g may refrain from applying the group-based beam reporting configuration to an uplink simultaneous transmission based on receiving an indication of multiple uplink beams. That is, if UE 115-g is indicated with two uplink beams (such as two TCIs, two spatial relation information, or two spatial transmit filters reported in a group based downlink beam reporting), UE 115-g may not expect to be indicated with an uplink simultaneous transmission.

At 1025, UE 115-g and TRP 205-j may communicate based on using the one or more uplink beams. For example, UE 115-g may transmit a multi-beam uplink transmission, including data or control signaling, based on enabling the group-based beam reporting.

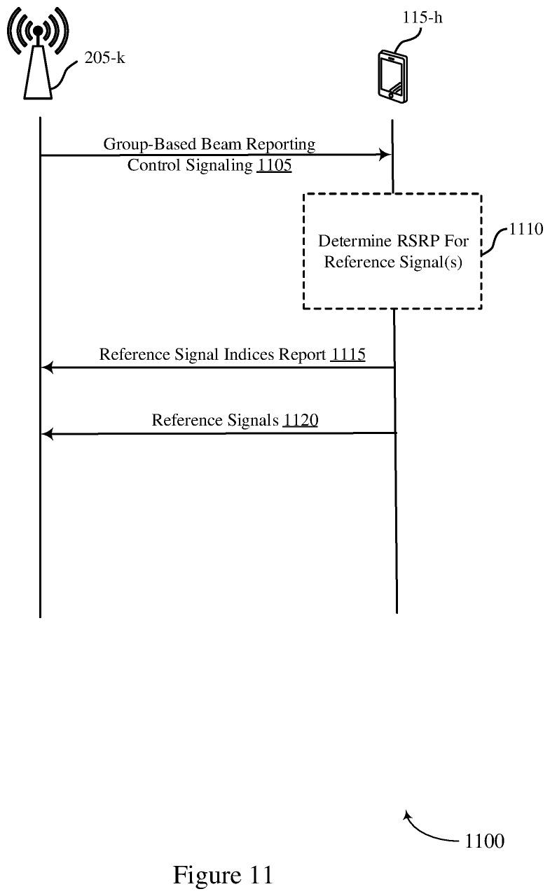

FIG. 11 illustrates an example of a process flow 1100 that supports common beam indication techniques for multi-beam operation. In some implementations, process flow 1100 may implement aspects of wireless communications system 100 through wireless communications system 300, beam diagram 400, beam diagram 500, transmission diagram 600 through transmission diagram 800, or a combination thereof. The process flow 1100 may illustrate an example of a TRP 205, such as TRP 205-k, transmit control signaling to a UE 115, such as UE 115-h, that enables a group-based beam reporting mode for an uplink transmission, such that UE 115-h may transmit one or more reference signals using multiple spatial domain transmit filters based on an index of a reference signal resource for each of the one or more reference signals. Alternative examples of the following may be implemented, where some processes are performed in a different order than described or are not performed. In some implementations, processes may include additional features not mentioned below, or further processes may be added.

At 1105, UE 115-h may receive control signaling enabling a group-based beam reporting mode for an uplink transmission at UE 115-h. For example, UE 115-g may receive an indication of one or more uplink beams including multiple TCI states, spatial relation information, multiple spatial transmit filters, or a combination.

At 1110, UE 115-h may determine RSRP values for one or more reference signals. For example, UE 115-h may calculate a difference between an RSRP for a reference signal with the greatest absolute value and the one or more RSRPs.

At 1115, UE 115-h may transmit a report including indices for multiple reference signal resources for the one or more reference signals. For example, the report may include an indication of an absolute value of the RSRP with the reference signal with the greatest RSRP value and the difference between the RSRP and any additional RSRPs for additional reference signals. The reference signal resources may include a CSI-RS resource, an SSB, an SRS resource, or a combination. In some implementations, the indices may be the same for each of the reference signal resources. In some other implementations, the indices may be different for each of the reference signal resources.

At 1120, UE 115-h may transmit one or more reference signals over the reference signal resources using multiple spatial domain transmit filters.

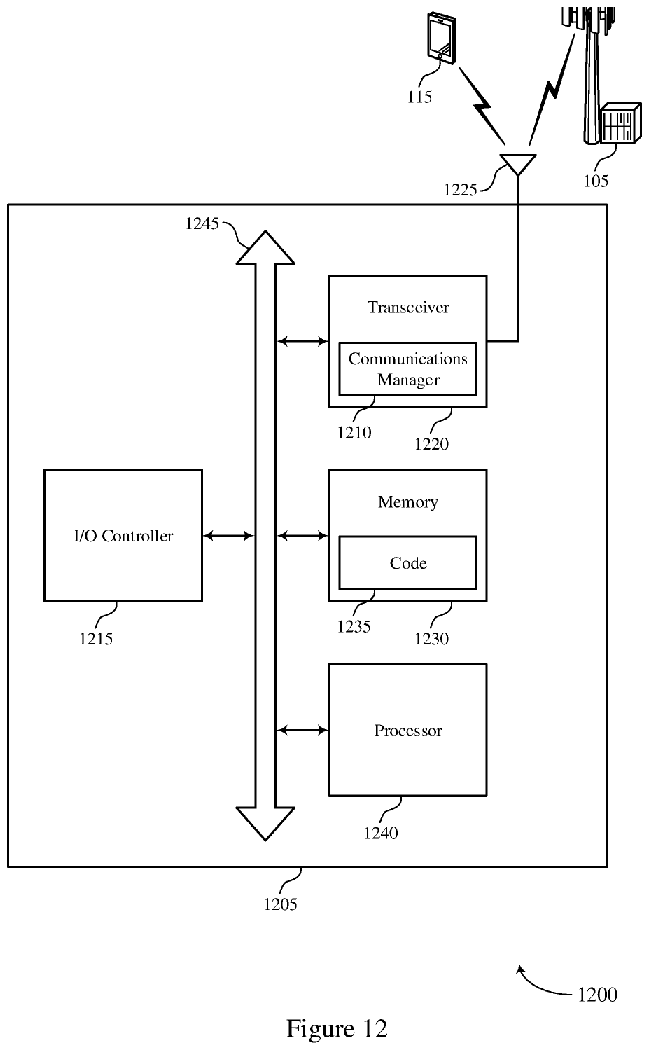

FIG. 12 shows a diagram of a system 1200 including a device 1205 that supports common beam indication techniques for multi-beam operation. The device 1205 may be an example of a UE 115 as described herein. The device 1205 may communicate wirelessly with one or more BSs 105, TRPs 205, UEs 115, or any combination thereof. The device 1205 may include components for bi-directional voice and data communications including components for transmitting and receiving communications, such as a communications manager 1220, an input/output (I/O) controller 1210, a transceiver 1215, an antenna 1225, a memory 1230, code 1235, and a processor 1240. These components may be in electronic communication or otherwise coupled (such as operatively, communicatively, functionally, electronically, electrically) via one or more buses (such as a bus 1245).

The I/O controller 1210 may manage input and output signals for the device 1205. The I/O controller 1210 also may manage peripherals not integrated into the device 1205. In some implementations, the I/O controller 1210 may represent a physical connection or port to an external peripheral. In some implementations, the I/O controller 1210 may utilize an operating system such as iOS®, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some implementations, the I/O controller 1210 may be implemented as part of a processor, such as the processor 1240. In some implementations, a user may interact with the device 1205 via the I/O controller 1210 or via hardware components controlled by the I/O controller 1210.

In some implementations, the device 1205 may include a single antenna 1225. However, in some other implementations, the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 also may include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter, a receiver, or any combination thereof or component thereof, as described herein.

The memory 1230 may include random access memory (RANI) and read-only memory (ROM). The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some implementations, the code 1235 may not be directly executable by the processor 1240 but may cause a computer (such as when compiled and executed) to perform functions described herein. In some implementations, the memory 1230 may contain, among other things, a basic I/O system (BIOS) which may control basic hardware or software operation such as the interaction with peripheral components or devices.

The processor 1240 may include an intelligent hardware device (such as a general-purpose processor, a DSP, a CPU, a microcontroller, an ASIC, an FPGA, a programmable logic device, a discrete gate or transistor logic component, a discrete hardware component, or any combination thereof). In some implementations, the processor 1240 may be configured to operate a memory array using a memory controller. In some other implementations, a memory controller may be integrated into the processor 1240. The processor 1240 may be configured to execute computer-readable instructions stored in a memory (such as the memory 1230) to cause the device 1205 to perform various functions (such as functions or tasks supporting common beam indication techniques for multi-beam operation). For example, the device 1205 or a component of the device 1205 may include a processor 1240 and memory 1230 coupled to the processor 1240, the processor 1240 and memory 1230 configured to perform various functions described herein.

The communications manager 1220 may support wireless communications at a wireless communication device in accordance with examples as disclosed herein. For example, the communications manager 1220 may be configured as or otherwise support a means for transmitting a beam report indicating a number of simultaneous transmit beams supported by the UE. The communications manager 1220 may be configured as or otherwise support a means for receiving control signaling including a common beam indication associated with a set of multiple TCI states. The communications manager 1220 may be configured as or otherwise support a means for selecting at least one TCI state of the set of multiple TCI states as an uplink component of a common beam, where the at least one TCI state is selected based on a selection criterion associated with the common beam indication and the number of simultaneous transmit beams supported by the UE. The communications manager 1220 may be configured as or otherwise support a means for communicating with a BS using the common beam.

Additionally, or alternatively, the communications manager 1220 may support wireless communications at a wireless communication device in accordance with examples as disclosed herein. For example, the communications manager 1220 may be configured as or otherwise support a means for receiving first control signaling enabling a group-based beam reporting mode at the UE. The communications manager 1220 may be configured as or otherwise support a means for receiving second control signaling including an indication associated with applying a group-based beam reporting configuration for uplink beam reporting. The communications manager 1220 may be configured as or otherwise support a means for selectively enabling or disabling the group-based beam reporting configuration to an uplink transmission, a downlink reception, or both based on the indication.

Additionally, or alternatively, the communications manager 1220 may support wireless communications at a wireless communication device in accordance with examples as disclosed herein. For example, the communications manager 1220 may be configured as or otherwise support a means for receiving first control signaling including a first indication associated with enabling a group-based beam reporting mode for an uplink transmission at the UE. The communications manager 1220 may be configured as or otherwise support a means for transmitting, in response to the first indication, a report including a set of multiple indices corresponding to a set of multiple reference signal resources. The communications manager 1220 may be configured as or otherwise support a means for transmitting a set of multiple reference signals over the set of multiple reference signal resources using a set of multiple spatial domain transmit filters based on the report.

In some implementations, the communications manager 1220 may be configured to perform various operations (such as receiving, monitoring, transmitting) using or otherwise in cooperation with the transceiver 1215, the one or more antennas 1225, or any combination thereof. Although the communications manager 1220 is illustrated as a separate component, In some implementations, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of common beam indication techniques for multi-beam operation as described herein, or the processor 1240 and the memory 1230 may be otherwise configured to perform or support such operations.

In some implementations, controller or processor 1240 may be a component of a processing system. A processing system may generally refer to a system or series of machines or components that receives inputs and processes the inputs to produce a set of outputs (which may be passed to other systems or components of, for example, the UE 115). For example, a processing system of the UE 115 may refer to a system including the various other components or subcomponents of the UE 115.

The processing system of the UE 115 may interface with other components of the UE 115, and may process information received from other components (such as inputs or signals), output information to other components, etc. For example, a chip or modem of the UE 115 may include a processing system, a first interface to receive or obtain information, and the first interface or a second interface to output, transmit or provide information. In some implementations, the first interface may refer to an interface between the processing system of the chip or modem and a receiver, such that the UE 115 may receive information or signal inputs, and the information may be passed to the processing system. In some implementations, the second interface may refer to an interface between the processing system of the chip or modem and a transmitter, such that the UE 115 may transmit information output from the chip or modem. A person having ordinary skill in the art will readily recognize that the second interface also may obtain or receive information or signal inputs, and the first interface also may output, transmit or provide information.

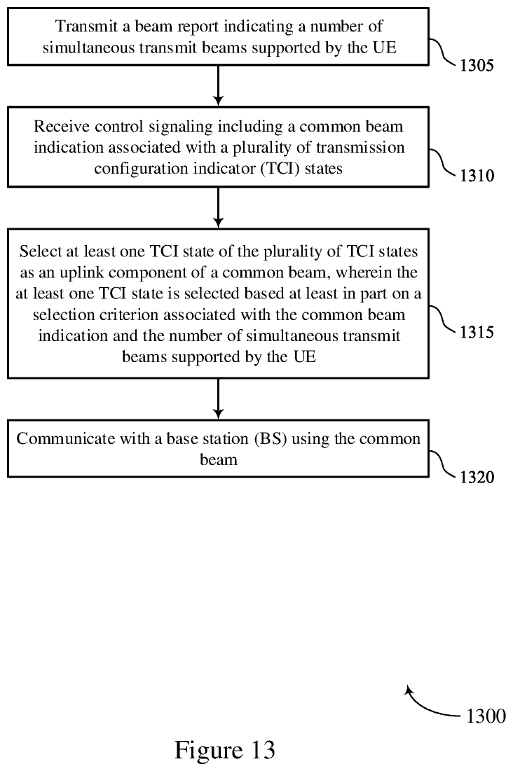

FIG. 13 shows a flowchart illustrating a method 1300 that supports common beam indication techniques for multi-beam operation. The operations of the method 1300 may be implemented by a UE or its components as described herein. For example, the operations of the method 1300 may be performed by a UE 115 as described with reference to FIG. 12. In some implementations, a UE may execute a set of instructions to control the functional elements of the UE to perform the described functions. Additionally, or alternatively, the UE may perform aspects of the described functions using special-purpose hardware.

At 1305, the method may include transmitting a beam report indicating a number of simultaneous transmit beams supported by the UE. The operations of 1305 may be performed in accordance with examples as disclosed herein. In some implementations, aspects of the operations of 1305 may be performed by a beam report component.

At 1310, the method may include receiving control signaling including a common beam indication associated with a set of multiple TCI states. The operations of 1310 may be performed in accordance with examples as disclosed herein. In some implementations, aspects of the operations of 1310 may be performed by a common beam component.

At 1315, the method may include selecting at least one TCI state of the set of multiple TCI states as an uplink component of a common beam, where the at least one TCI state is selected based on a selection criterion associated with the common beam indication and the number of simultaneous transmit beams supported by the UE. The operations of 1315 may be performed in accordance with examples as disclosed herein. In some implementations, aspects of the operations of 1315 may be performed by a TCI state component.

At 1320, the method may include communicating with a BS using the common beam. The operations of 1320 may be performed in accordance with examples as disclosed herein. In some implementations, aspects of the operations of 1320 may be performed by a common beam component.

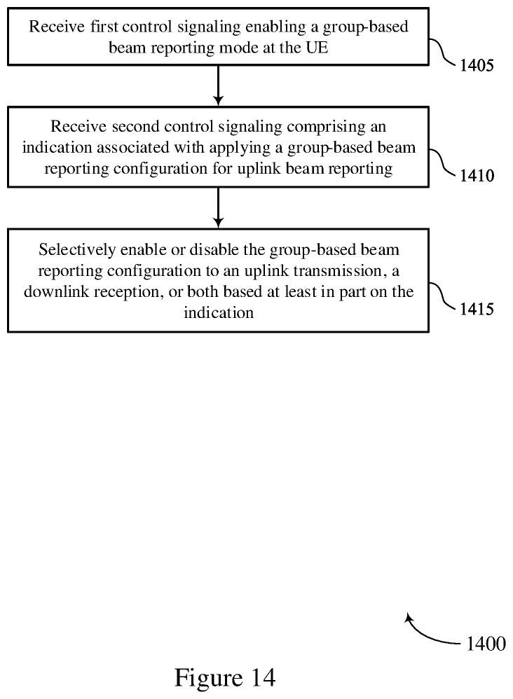

FIG. 14 shows a flowchart illustrating a method 1400 that supports common beam indication techniques for multi-beam operation. The operations of the method 1400 may be implemented by a UE or its components as described herein. For example, the operations of the method 1400 may be performed by a UE 115 as described with reference to FIG. 12. In some implementations, a UE may execute a set of instructions to control the functional elements of the UE to perform the described functions. Additionally, or alternatively, the UE may perform aspects of the described functions using special-purpose hardware.

At 1405, the method may include receiving first control signaling enabling a group-based beam reporting mode at the UE. The operations of 1405 may be performed in accordance with examples as disclosed herein. In some implementations, aspects of the operations of 1405 may be performed by a beam reporting mode component.

At 1410, the method may include receiving second control signaling including an indication associated with applying a group-based beam reporting configuration for uplink beam reporting. The operations of 1410 may be performed in accordance with examples as disclosed herein. In some implementations, aspects of the operations of 1410 may be performed by a transmit beam component.

At 1415, the method may include selectively enabling or disabling the group-based beam reporting configuration to an uplink transmission, a downlink reception, or both based on the indication. The operations of 1415 may be performed in accordance with examples as disclosed herein. In some implementations, aspects of the operations of 1415 may be performed by a beam reporting mode component.

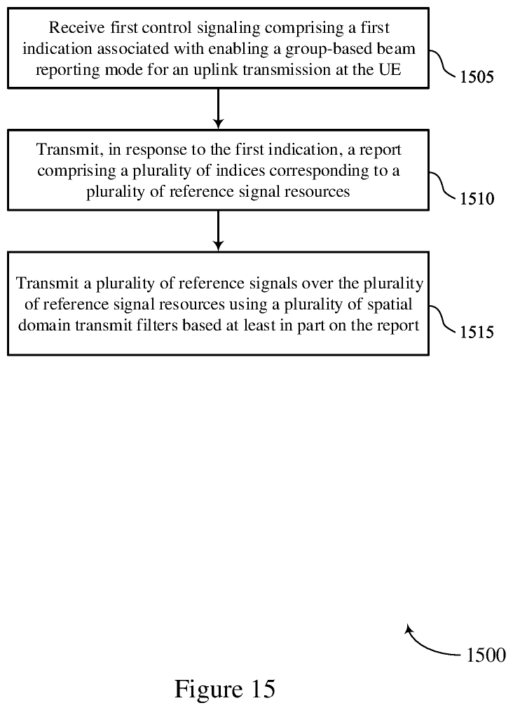

FIG. 15 shows a flowchart illustrating a method 1500 that supports common beam indication techniques for multi-beam operation. The operations of the method 1500 may be implemented by a UE or its components as described herein. For example, the operations of the method 1500 may be performed by a UE 115 as described with reference to FIG. 12. In some implementations, a UE may execute a set of instructions to control the functional elements of the UE to perform the described functions. Additionally, or alternatively, the UE may perform aspects of the described functions using special-purpose hardware.

At 1505, the method may include receiving first control signaling including a first indication associated with enabling a group-based beam reporting mode for an uplink transmission at the UE. The operations of 1505 may be performed in accordance with examples as disclosed herein. In some implementations, aspects of the operations of 1505 may be performed by a beam reporting mode component.

At 1510, the method may include transmitting, in response to the first indication, a report including a set of multiple indices corresponding to a set of multiple reference signal resources. The operations of 1510 may be performed in accordance with examples as disclosed herein. In some implementations, aspects of the operations of 1510 may be performed by a reference signal component.

At 1515, the method may include transmitting a set of multiple reference signals over the set of multiple reference signal resources using a set of multiple spatial domain transmit filters based on the report. The operations of 1515 may be performed in accordance with examples as disclosed herein. In some implementations, aspects of the operations of 1515 may be performed by a spatial domain transmit filter component.

The following provides an overview of aspects of the present disclosure:

Aspect 1: A method for wireless communications at a wireless communication device, including: transmitting a beam report indicating a number of simultaneous transmit beams supported by the UE; receiving control signaling including a common beam indication associated with a plurality of transmission configuration indicator (TCI) states; selecting at least one TCI state of the plurality of TCI states as an uplink component of a common beam, where the at least one TCI state is selected based at least in part on a selection criterion associated with the common beam indication and the number of simultaneous transmit beams supported by the UE; and communicating with a base station (BS) using the common beam.

Aspect 2: The method of aspect 1, where communicating with the BS includes: receiving signaling based at least in part on applying one or more quasi-collocation (QCL) criteria corresponding to the at least one TCI state for a downlink reception.

Aspect 3: The method of any of aspects 1 through 2, where communicating with the BS includes: transmitting signaling based at least in part on applying one or more quasi-collocation (QCL) criteria, spatial transmit filters, or both corresponding to the at least one TCI state for an uplink transmission.

Aspect 4: The method of any of aspects 1 through 3, where selecting the at least one TCI state includes: selecting a single TCI state, where the selection criterion includes a TCI state identifier, a TCI state index, a synchronization signal block (SSB) identifier corresponding to the single TCI state, a downlink reception occasion with a lowest control resource set (CORESET) identifier corresponding to the single TCI state, a lowest search space identifier corresponding to the single TCI state, a lower portion of a frequency domain resource allocation corresponding to the single TCI state, an earlier time domain resource allocation corresponding to the single TCI state, or a combination thereof.

Aspect 5: The method of any of aspects 1 through 4, where selecting the at least one TCI state includes: receiving an indication of the plurality of TCI states using a plurality of simultaneous spatial domain receive filters; and selecting a single TCI state based at least in part on using the plurality of simultaneous spatial domain receive filters.

Aspect 6: The method of any of aspects 1 through 4, where selecting the at least one TCI state includes: receiving an indication of the plurality of TCI states using a single spatial domain receive filter; and selecting a pair of TCI states from the plurality of TCI states based at least in part on using the single spatial domain receive filter.

Aspect 7: The method of any of aspects 1 through 6, further including: receiving a configuration including a first multiplexing mode for a downlink multi-beam reception, a second multiplexing mode for an uplink multi-beam transmission, or both associated with the common beam indication.

Aspect 8: The method of aspect 7, where the first multiplexing mode, the second multiplexing mode, or both include a spatial division multiplexing (SDM) mode, a time division multiplexing (TDM) mode, a frequency division multiplexing (FDM) mode, a single-frequency network (SFN) mode, or a combination thereof.

Aspect 9: The method of any of aspects 1 through 8, where receiving the control signaling includes: receiving an indication of a first TCI state of the plurality of TCI states and a second TCI state of the plurality of TCI states for the common beam, where the common beam is associated with downlink reception and uplink transmission; and applying the first TCI state and the second TCI state for a plurality of downlink reception occasions, a plurality of uplink transmission occasions, or both based at least in part on a control resource set (CORESET), a search space identifier, a frequency domain resource allocation, a time domain resource allocation, or a combination thereof.

Aspect 10: The method of aspect 9, further including: applying the first TCI state to a first downlink reception occasion and a first uplink transmission occasion; and applying the second TCI state to a second downlink reception occasion and a second uplink transmission occasion.

Aspect 11: The method of any of aspects 1 through 10, where receiving the control signaling includes: receiving an indication of a first TCI state of the plurality of TCI states and a second TCI state of the plurality of TCI states for the common beam, where the common beam is associated with downlink reception and uplink transmission; applying a first pathloss corresponding to a first reference signal associated with the first TCI state to a first uplink transmission occasion; and applying a second pathloss corresponding to a second reference signal associated with the second TCI state to a second uplink transmission occasion.

Aspect 12: The method of any of aspects 1 through 11, where receiving the control signaling includes: receiving an indication of a first TCI state of the plurality of TCI states and a second TCI state of the plurality of TCI states for the common beam, where the common beam is associated with downlink reception and uplink transmission; applying a first timing advance associated with the first TCI state to a first uplink transmission occasion; and applying a second timing advance associated with the second TCI state to a second uplink transmission occasion.

Aspect 13: A method for wireless communications at a wireless communication device, including: receiving first control signaling enabling a group-based beam reporting mode at the UE; receiving second control signaling including an indication associated with applying a group-based beam reporting configuration for uplink beam reporting; and selectively enabling or disabling the group-based beam reporting configuration to an uplink transmission, a downlink reception, or both based at least in part on the indication.

Aspect 14: The method of aspect 13, where receiving the first control signaling includes: receiving an indication of a plurality of uplink beams including a plurality of transmission configuration indicator (TCI) states, spatial relation information, a plurality of spatial transmit filters, or a combination; and applying the group-based beam reporting configuration for the plurality of uplink beams based at least in part on the indication.

Aspect 15: The method of aspect 14, further including: refraining from applying the group-based beam reporting configuration to an uplink simultaneous transmission based at least in part on receiving the indication of the plurality of uplink beams.

Aspect 16: The method of any of aspects 13 through 15, where receiving the second control signaling includes: receiving a configuration for a single receive beam; and enabling group-based beam reporting for the downlink reception based at least in part on the single receive beam.

Aspect 17: The method of any of aspects 13 through 15, where receiving the second control signaling includes: receiving a configuration for a plurality of receive beams; and enabling group-based beam reporting for the downlink reception based at least in part on the plurality of receive beams.

Aspect 18: The method of any of aspects 13 through 17, where the indication associated with applying the group-based beam reporting configuration for the uplink beam reporting includes one or more bits in a CSI report, a UE capability report, or both.

Aspect 19: A method for wireless communications at a wireless communication device, including: receiving first control signaling including a first indication associated with enabling a group-based beam reporting mode for an uplink transmission at the UE; transmitting, in response to the first indication, a report including a plurality of indices corresponding to a plurality of reference signal resources; and transmitting a plurality of reference signals over the plurality of reference signal resources using a plurality of spatial domain transmit filters based at least in part on the report.

Aspect 20: The method of aspect 19, further including: transmitting a report including a downlink reference signal received power (RSRP) for each of the plurality of reference signal resources.

Aspect 21: The method of aspect 20, further including: determining a first downlink RSRP for a first reference signal associated with a first reference signal resource of the plurality of reference signal resources and a second RSRP for a second reference signal associated with a second reference signal resource of the plurality of reference signal resources; calculating a difference between the first downlink RSRP and the second RSRP; and transmitting an indication of an absolute value of the first downlink RSRP and the difference between the first downlink RSRP and the second RSRP, where the report includes the indication.

Aspect 22: The method of any of aspects 19 through 21, where the plurality of indices are the same for each of the plurality of reference signal resources.

Aspect 23: The method of any of aspects 19 through 21, where the plurality of indices are different for each of the plurality of reference signal resources.

Aspect 24: The method of any of aspects 19 through 23, where the plurality of reference signal resources include a channel state information-reference signal (CSI-RS) resource, a synchronization signal block (SSB), an SRS resource, or a combination thereof.

Aspect 25: An apparatus for wireless communications at a wireless communication device, including a processor; memory coupled with the processor; and instructions stored in the memory and executable by the processor to cause the apparatus to perform a method of any of aspects 1 through 12.

Aspect 26: An apparatus for wireless communications at a wireless communication device, including at least one means for performing a method of any of aspects 1 through 12.

Aspect 27: A non-transitory computer-readable medium storing code for wireless communications at a wireless communication device, the code including instructions executable by a processor to perform a method of any of aspects 1 through 12.

Aspect 28: An apparatus for wireless communications at a wireless communication device, including a processor; memory coupled with the processor; and instructions stored in the memory and executable by the processor to cause the apparatus to perform a method of any of aspects 13 through 18.

Aspect 29: An apparatus for wireless communications at a wireless communication device, including at least one means for performing a method of any of aspects 13 through 18.

Aspect 30: A non-transitory computer-readable medium storing code for wireless communications at a wireless communication device, the code including instructions executable by a processor to perform a method of any of aspects 13 through 18.

Aspect 31: An apparatus for wireless communications at a wireless communication device, including a processor; memory coupled with the processor; and instructions stored in the memory and executable by the processor to cause the apparatus to perform a method of any of aspects 19 through 24.

Aspect 32: An apparatus for wireless communications at a wireless communication device, including at least one means for performing a method of any of aspects 19 through 24.

Aspect 33: A non-transitory computer-readable medium storing code for wireless communications at a wireless communication device, the code including instructions executable by a processor to perform a method of any of aspects 19 through 24.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, such as, one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some implementations be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some implementations, the actions recited in the claims can be performed in a different order and still achieve desirable results.

1. An apparatus for wireless communications, comprising:
a first interface configured to:
output a beam report indicating a number of simultaneous transmit beams supported by a user equipment (UE);
the first interface or a second interface configured to:
obtain control signaling including a common beam indication associated with a plurality of transmission configuration indicator (TCI) states; and
a processing system configured to:
select at least one TCI state of the plurality of TCI states as an uplink component of a common beam, wherein the at least one TCI state is selected based at least in part on a selection criterion associated with the common beam indication and the number of simultaneous transmit beams supported by the UE;
wherein the first interface or the second interface is configured to:
communicate with a base station (BS) using the common beam.

2. The apparatus of claim 1, wherein the first interface or the second interface is further configured to:
obtain signaling based at least in part on applying one or more quasi-collocation (QCL) criteria corresponding to the at least one TCI state for a downlink reception.

3. The apparatus of claim 1, wherein the first interface or the second interface is further configured to:
output signaling based at least in part on applying one or more quasi-collocation (QCL) criteria, spatial transmit filters, or both corresponding to the at least one TCI state for an uplink transmission.

4. The apparatus of claim 1, wherein the processing system is configured to:
select a single TCI state, wherein the selection criterion comprises a TCI state identifier, a TCI state index, a synchronization signal block (SSB) identifier corresponding to the single TCI state, a downlink reception occasion with a lowest control resource set (CORESET) identifier corresponding to the single TCI state, a lowest search space identifier corresponding to the single TCI state, a lower portion of a frequency domain resource allocation corresponding to the single TCI state, an earlier time domain resource allocation corresponding to the single TCI state, or a combination thereof.

5. The apparatus of claim 1, wherein:
the first interface or the second interface is further configured to:
obtain an indication of the plurality of TCI states using a plurality of simultaneous spatial domain receive filters; and
the processing system is further configured to:
select a single TCI state based at least in part on using the plurality of simultaneous spatial domain receive filters.

6. The apparatus of claim 1, wherein:
the first interface or the second interface is further configured to:
obtain an indication of the plurality of TCI states using a single spatial domain receive filter; and
the processing system is further configured to:
select a pair of TCI states from the plurality of TCI states based at least in part on using the single spatial domain receive filter.

7. The apparatus of claim 1, wherein the first interface or the second interface is further configured to:
obtain a configuration comprising a first multiplexing mode for a downlink multi-beam reception, a second multiplexing mode for an uplink multi-beam transmission, or both associated with the common beam indication.

8. The apparatus of claim 7, wherein the first multiplexing mode, the second multiplexing mode, or both comprise a spatial division multiplexing (SDM) mode, a time division multiplexing (TDM) mode, a frequency division multiplexing (FDM) mode, a single-frequency network (SFN) mode, or a combination thereof.

9. The apparatus of claim 1, wherein:
the first interface or the second interface is further configured to:
obtain an indication of a first TCI state of the plurality of TCI states and a second TCI state of the plurality of TCI states for the common beam, wherein the common beam is associated with downlink reception and uplink transmission; and
the processing system is further configured to:
apply the first TCI state and the second TCI state for a plurality of downlink reception occasions, a plurality of uplink transmission occasions, or both based at least in part on a control resource set (CORESET), a search space identifier, a frequency domain resource allocation, a time domain resource allocation, or a combination thereof.

10. The apparatus of claim 9, wherein the processing system is further configured to:
apply the first TCI state to a first downlink reception occasion and a first uplink transmission occasion; and
apply the second TCI state to a second downlink reception occasion and a second uplink transmission occasion.

11. The apparatus of claim 1, wherein:
the first interface or the second interface is further configured to:
obtain an indication of a first TCI state of the plurality of TCI states and a second TCI state of the plurality of TCI states for the common beam, wherein the common beam is associated with downlink reception and uplink transmission;
the processing system is further configured to:
apply a first pathloss corresponding to a first reference signal associated with the first TCI state to a first uplink transmission occasion; and
apply a second pathloss corresponding to a second reference signal associated with the second TCI state to a second uplink transmission occasion.

12. The apparatus of claim 1, wherein:
the first interface or the second interface is further configured to:
obtain an indication of a first TCI state of the plurality of TCI states and a second TCI state of the plurality of TCI states for the common beam, wherein the common beam is associated with downlink reception and uplink transmission;
the processing system is further configured to:
apply a first timing advance associated with the first TCI state to a first uplink transmission occasion; and
apply a second timing advance associated with the second TCI state to a second uplink transmission occasion.

13. An apparatus for wireless communications, comprising:
a first interface configured to:
obtain first control signaling enabling a group-based beam reporting mode at a user equipment (UE);
obtain second control signaling comprising an indication associated with applying a group-based beam reporting configuration for uplink beam reporting; and
a processing system configured to:
selectively enable or disable the group-based beam reporting configuration to an uplink transmission, a downlink reception, or both based at least in part on the indication.

14. The apparatus of claim 13, wherein:
the first interface or a second interface is further configured to:
obtain an indication of a plurality of uplink beams comprising a plurality of transmission configuration indicator (TCI) states, spatial relation information, a plurality of spatial transmit filters, or a combination; and
the processing system is further configured to:
apply the group-based beam reporting configuration for the plurality of uplink beams based at least in part on the indication.

15. The apparatus of claim 14, wherein the first interface or a second interface is further configured to:
refrain from applying the group-based beam reporting configuration to an uplink simultaneous transmission based at least in part on obtaining the indication of the plurality of uplink beams.

16. The apparatus of claim 13, wherein:
the first interface or a second interface is further configured to:
obtain a configuration for a single receive beam; and
the processing system is further configured to:
enable group-based beam reporting for the downlink reception based at least in part on the single receive beam.

17. The apparatus of claim 13, wherein:
the first interface or a second interface is further configured to:
obtain a configuration for a plurality of receive beams; and
the processing system is further configured to:
enable group-based beam reporting for the downlink reception based at least in part on the plurality of receive beams.

18. The apparatus of claim 13, wherein the indication associated with applying the group-based beam reporting configuration for the uplink beam reporting comprises one or more bits in a channel state information (CSI) report, a UE capability report, or both.

19-24. (canceled)

25. A method for wireless communications at a wireless communication device, comprising:
transmitting a beam report indicating a number of simultaneous transmit beams supported by a user equipment (UE);
receiving control signaling including a common beam indication associated with a plurality of transmission configuration indicator (TCI) states;
selecting at least one TCI state of the plurality of TCI states as an uplink component of a common beam, wherein the at least one TCI state is selected based at least in part on a selection criterion associated with the common beam indication and the number of simultaneous transmit beams supported by the UE; and
communicating with a base station (BS) using the common beam.

26-30. (canceled)

31. The method of claim 25, further comprising:
receiving a configuration comprising a first multiplexing mode for a downlink multi-beam reception, a second multiplexing mode for an uplink multi-beam transmission, or both associated with the common beam indication.

32. The method of claim 31, wherein the first multiplexing mode, the second multiplexing mode, or both comprise a spatial division multiplexing (SDM) mode, a time division multiplexing (TDM) mode, a frequency division multiplexing (FDM) mode, a single-frequency network (SFN) mode, or a combination thereof.

33. The method of claim 25, wherein receiving the control signaling comprises:
receiving an indication of a first TCI state of the plurality of TCI states and a second TCI state of the plurality of TCI states for the common beam, wherein the common beam is associated with downlink reception and uplink transmission; and
applying the first TCI state and the second TCI state for a plurality of downlink reception occasions, a plurality of uplink transmission occasions, or both based at least in part on a control resource set (CORESET), a search space identifier, a frequency domain resource allocation, a time domain resource allocation, or a combination thereof.

34. The method of claim 33, further comprising:
applying the first TCI state to a first downlink reception occasion and a first uplink transmission occasion; and
applying the second TCI state to a second downlink reception occasion and a second uplink transmission occasion.

35. The method of claim 25, wherein receiving the control signaling comprises:
receiving an indication of a first TCI state of the plurality of TCI states and a second TCI state of the plurality of TCI states for the common beam, wherein the common beam is associated with downlink reception and uplink transmission;
applying a first pathloss corresponding to a first reference signal associated with the first TCI state to a first uplink transmission occasion; and
applying a second pathloss corresponding to a second reference signal associated with the second TCI state to a second uplink transmission occasion.

36. The method of claim 25, wherein receiving the control signaling comprises:
receiving an indication of a first TCI state of the plurality of TCI states and a second TCI state of the plurality of TCI states for the common beam, wherein the common beam is associated with downlink reception and uplink transmission;
applying a first timing advance associated with the first TCI state to a first uplink transmission occasion; and
applying a second timing advance associated with the second TCI state to a second uplink transmission occasion.

37. A method for wireless communications at a wireless communication device, comprising:
receiving first control signaling enabling a group-based beam reporting mode at a user equipment (UE);
receiving second control signaling comprising an indication associated with applying a group-based beam reporting configuration for uplink beam reporting; and
selectively enabling or disabling the group-based beam reporting configuration to an uplink transmission, a downlink reception, or both based at least in part on the indication.

38. The method of claim 37, wherein receiving the first control signaling comprises:
receiving an indication of a plurality of uplink beams comprising a plurality of transmission configuration indicator (TCI) states, spatial relation information, a plurality of spatial transmit filters, or a combination; and
applying the group-based beam reporting configuration for the plurality of uplink beams based at least in part on the indication.

39. (canceled)

40. The method of claim 37, wherein receiving the second control signaling comprises:
receiving a configuration for a single receive beam; and
enabling group-based beam reporting for the downlink reception based at least in part on the single receive beam.

41. The method of claim 37, wherein receiving the second control signaling comprises:
receiving a configuration for a plurality of receive beams; and
enabling group-based beam reporting for the downlink reception based at least in part on the plurality of receive beams.

42. The method of claim 37, wherein the indication associated with applying the group-based beam reporting configuration for the uplink beam reporting comprises one or more bits in a channel state information (CSI) report, a UE capability report, or both.

43-72. (canceled)
